(19) United States
(12) Patent Application Publication
(10) Pub. No.: US 2011/0189581 A1
(43) Pub. Date: Aug. 4, 2011

(54) COMPOUND, CROSS-LINKED MATERIAL THEREOF, DOUBLE CROSS-LINKED POLYMER THEREOF, AND ELECTROLYTE MEMBRANE, ELECTRODE FOR FUEL CELL AND FUEL CELL INCLUDING SAME

(75) Inventors: Seong-woo CHOI, Yongin-si (KR); Jong-chan Lee, Seoul (KR); Jung-ock Park, Yongin-si (KR); Sung-kon Kim, Seoul (KR); Jung-woo Jung, Seoul (KR)

(73) Assignees: SAMSUNG ELECTRONICS CO., LTD., Suwon-si (KR); SNU R&DB FOUNDATION, Seoul (KR)

(21) Appl. No.: 13/020,035

(22) Filed: Feb. 3, 2011

(30) Foreign Application Priority Data
Feb. 4, 2010 (KR) 10-2010-0010495
Jan. 21, 2011 (KR) 10-2011-0006491

(51) Int. Cl. H01M 8/10; H01M 4/90; C08G 73/18; C08G 79/04

(52) U.S. Cl. 429/482; 429/492; 528/342; 525/435

(57) ABSTRACT

A compound having an amino group at a terminal thereof and at least one amino group in a repeating unit, a cross-linked material of the compound, a double cross-linked polymer thereof, an electrolyte membrane and an electrode for a fuel cell, which include the cross-linked material of the compound or the double cross-linked polymer thereof, and a fuel cell including at least one of the electrolyte membrane and the electrode.

### CROSS-REFERENCE TO RELATED APPLICATIONS

This application claims the benefit of Korean Patent Application Nos. 10-2010-0010495, filed Feb. 4, 2010, and 10-2011-0006491, filed Jan. 21, 2011, both filed in the Korean Intellectual Property Office, the disclosures of which are incorporated herein by reference.

### BACKGROUND

1. Field

Aspects of the present disclosure relate to a compound, a cross-linked material thereof, a double cross-linked polymer thereof, an electrolyte membrane and an electrode for a fuel cell, which include the cross-linked material of the compound, and a fuel cell including at least one of the electrolyte membrane and the electrode.

2. Description of the Related Art

Fuel cells that include a polymer electrolyte membrane may operate at relatively low temperatures and may be manufactured in small sizes. Thus, such fuel cells are expected to be used as energy sources in electric vehicles and in distributed generation systems. Perfluorocarbon sulfonic acid-based polymer membranes, such as NAFION membranes (available from E.I. du Pont de Nemours and Company), are commonly used as polymer electrolyte membranes for fuel cells.

However, such polymer electrolyte membranes should be humidified in order to sufficiently conduct protons. In addition, to enhance cell system efficiencies, polymer electrolyte membranes should be operated at high temperatures, i.e., at least 100° C. However, the moisture in the polymer electrolyte membrane is evaporated and depleted at such temperatures, which reduces the effectiveness thereof.

To address such problems and/or other problems in the related art, phosphoric acid-doped polybenzimidazoles have been developed as a material for non-humidified electrolyte membranes, which may operate at temperatures of at least 100° C. without humidification.

In addition, phosphoric acid fuel cells, which operate at temperatures of from 150 to 200° C., include a liquid phosphoric acid electrolyte. However, the liquid phosphoric acid included in a large amount in electrodes interferes with gas diffusion in the electrodes. Therefore, an electrode catalyst layer that includes a polytetrafluoroethylene (PTFE) waterproofing agent, which prevents fine pores in the electrodes from being clogged by the phosphoric acid, has been used.

In addition, in a fuel cell including a high-temperature, non-humidified electrolyte membrane formed of a phosphoric acid-doped polybenzimidazole (PBI), when air is supplied to the cathode, the activation time thereof is about 1 week even when an optimized electrode composition is used. Although the performance of the solid polymer electrolyte may be improved, and the activation time may be shortened, as air supplied to the anode is replaced with oxygen, this replacement is undesirable for commercial use. Furthermore, an electrolyte membrane prepared using a homopolymer of PBI does not have sufficient mechanical properties, chemical stability, and capability to retain phosphoric acid at a high temperature. Therefore, there is still a demand for improvement.

### SUMMARY

Provided are a compound having an amino group at a terminal thereof and at least one amino group in a repeating unit, a cross-linked material of the compound, a double cross-linked polymer thereof, an electrolyte membrane and an electrode for a fuel cell, which include the cross-linked material of the compound or the double cross-linked polymer thereof, and a fuel cell including at least one of the electrolyte membrane and the electrode.

According to an aspect of the present invention, a compound, is represented by Formula 1 below:

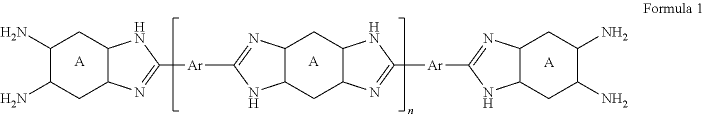

wherein, in Formula 1,

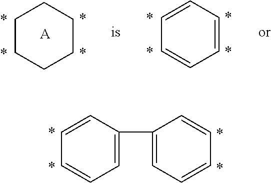

Ar is a substituted or unsubstituted C₆-C₂₀ arylene group or a substituted or unsubstituted C₃-C₂₀ hetero arylene group; and

n is a number from 1 to 300.

Another aspect of the present invention provides a cross-linked material of the compound.

According to another aspect of the present invention, a double cross-linked polymer obtained through a cross-linking reaction of a composition includes the cross-linked material and a oxazine-based monomer.

According to another aspect of the present invention, in an electrolyte membrane for a fuel cell, the electrolyte membrane includes the cross-linked material.

According to another aspect of the present invention, an electrolyte membrane for a fuel cell includes the double cross-linked polymer.

According to another aspect of the present invention, an electrode for a fuel cell includes the cross-linked material.

According to another aspect of the present invention, an electrode for a fuel cell includes the double cross-linked polymer.

According to another aspect of the present invention, a fuel cell includes a cathode; an anode; and an electrolyte membrane disposed between the cathode and the anode, wherein at least one of the cathode, the anode and the electrolyte membrane includes the cross-linked material.

According to another aspect of the present invention, a fuel cell includes a cathode; an anode; and an electrolyte membrane disposed between the cathode and the anode, wherein at least one of the cathode, the anode and the electrolyte membrane includes the double cross-linked polymer.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following description of the embodiments, taken in conjunction with the accompanying drawings, of which:

FIG. 1 shows a nuclear magnetic resonance (NMR) spectrum of the compound prepared in Synthesis Example 2;

FIG. 2 shows infrared (IR) spectra of a cross-linked material and polybenzimidazole prepared in Examples 1-1 and 1-2;

FIG. 3 is a graph of tensile strength of the electrolyte membrane prepared in Example 1-1;

FIG. 4 is a graph of voltages with respect to current density of fuel cells manufactured in Manufacture Examples 1 and 2; and

FIG. 5 is a graph of voltages with respect to current density of fuel cells manufactured in Manufacture Example 3.

### DETAILED DESCRIPTION

Reference will now be made in detail to the present embodiments of the present invention, examples of which are illustrated in the accompanying drawings. The embodiments are described below in order to explain the present invention by referring to the figures.

A compound includes amino groups at both ends thereof, and at least one amino group in a repeating unit.

The compound may be obtained by a reaction of an aromatic and/or heteroaromatic carboxylic acid including at least two acid groups per carboxylic acid monomer, an aromatic and/or heteroaromatic tetramino compound, and polyphosphoric acid.

In addition to the polyphosphoric acid, organic phosphorus acid anhydride, phosphorus pentoxide in methanesulfonic acid solution (Eaton's reagent), or the like may be used.

The phosphorus pentoxide in methanesulfonic acid solution, for example, may be about 7.7 wt % of phosphorus pentoxide solution in methanesulfonic acid available from the Sigma-Aldrich Company.

Examples of polyphosphoric acid include known phosphoric acids, for example, available from Riedel-de Haen Inc. The concentration of the polyphosphoric acid, which is represented by Hₙ₊₂PₙO₃ₙ₊₁ (n>1), may be at least 85%, calculated as P₂O₅ (by acidimetry).

The amount of the polyphosphoric acid is in the range of about 1000 to about 10,000 parts by weight based on 100 parts by weight of aromatic and/or heteroaromatic carboxylic acid. When the amount of the polyphosphoric acid is within this range, a target compound may be obtained with a high yield.

The amount of the aromatic and/or heteroaromatic tetramino compound is in the range of about 1 to about 2 mol based on 1 mol of aromatic and/or heteroaromatic carboxylic acid including at least two acid groups per a carboxylic acid monomer. When the amount of the aromatic and/or heteroaromatic tetramino compound is within this range, the target compound may be obtained with a high yield.

The aromatic and/or heteroaromatic carboxylic acid may be a C₃-C₃₀ compound, and may be at least one selected from the group consisting of isophthalic acid, terephthalic acid, phthalic acid, 1,4,-naphthalene dicarboxylic acid, 1,5-naphthalene dicarboxylic acid, 2,6-naphthalene dicarboxylic acid, 2,7-naphthalene dicarboxylic acid, diphenic acid, 1,8-dihydroxynaphthalene-3,6-dicarboxylic acid, diphenylether-4,4′-dicarboxylic acid, benzophenone-4,4′-dicarboxylic acid, diphenylsulfone-4,4′-dicarboxylic acid, biphenyl-4,4′-dicarboxylic acid, diphenylsulfone-4,4′-dicarboxylic acid, 4-trifluoromethylphthalic acid, 4,4′-stilbenedicarboxylic acid, pyridine-3,5-dicarboxylic acid, pyridine-2,5-dicarboxylic acid, pyridine-2,6-dicarboxylic acid, pyridine-2,4-dicarboxylic acid, 4-phenyl-2,5-pyridinedicarboxylic acid, 3,5-pyrazole dicarboxylic acid, 2,6-pyrimidinedicarboxylic acid, 2,5-pyrazinedicarboxylic acid, 2,4,6-pyridine tricarboxylic acid, and benzimidazole-5,6-dicarboxylic acid.

The aromatic and/or heteroaromatic tetramino compound may be a C₄-C₃₀ compound, and may be at least one selected from the group consisting of 3,3′,4,4′-tetraminobiphenyl, 2,3,5,6-tetraminopyridine, 1,2,4,5-tetraminobenzene, 3,3′,4,4′-tetraminobenzophenone, 3,3′,4,4′-tetraminodiphenyl sulfone, 3,3′,4,4′-tetraminodiphenyl ether, 3,3′,4,4′-tetraminodiphenylmethane, and 3,3′,4,4′-tetraminodiphenyldimethylmethane.

The reaction of the carboxylic acid, the aromatic and/or heteroaromatic tetramino compound, and the polyphosphoric acid is performed at a reaction temperature of about 60 to about 250° C. When the reaction temperature is within this range, the diamine-terminated polyazole-based material may be obtained with a high yield.

The compound having an amino group at a terminal thereof and at least one amino group in a repeating unit may be represented by, but is not limited to, Formula 1 below.

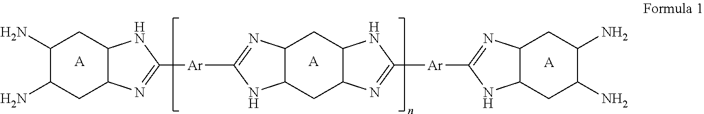

wherein, in Formula 1,

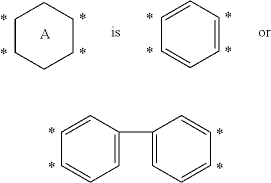

Ar is a substituted or unsubstituted C₆-C₂₀ arylene group or a substituted or unsubstituted C₃-C₂₀ heteroarylene group, and n may be a number from 1 to 300,

In Formula 1, * denotes the sites at which an adjacent group is linked. In Formula 1A, Ar is selected from the group represented by Formula 1A below.

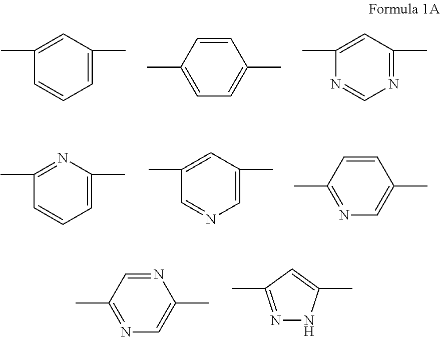

The diamine-terminated polyazole-based material may be represented by Formula 2 or 3 below:

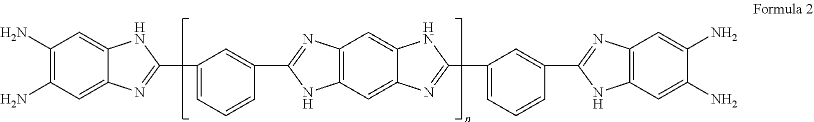

In Formula 2, n may be a number from 1 to 300.

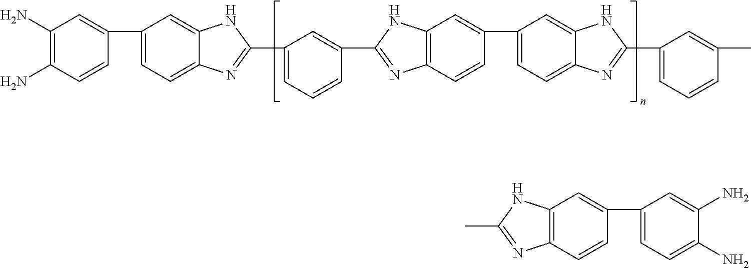

In Formula 3, n may be a number from 1 to 300.

The compound represented by Formula 1 above includes an amino group at an end thereof. Thus, when the diamine-terminated polyazole-based material reacts with at least one carboxylic acid selected from aromatic tricarboxylic acid heteroaromatic tricarboxylic acid, aromatic tetracarboxylic acid, and heteroaromatic tetracarboxylic acid, the carboxylic acid functions as a cross-linking agent, thereby obtaining a cross-linked material of the compound represented by Formula 1.

The polyazole-based material is a polymer having a repeating unit including at least one aryl ring having at least one nitrogen atom.

The aryl ring may be a 5-membered or 6-membered atom ring fused to a ring, such as another aryl ring or a heteroaryl ring, wherein the 5-membered or 6-membered atom ring includes one to three nitrogen atoms. In this regard, the nitrogen atoms may be substituted with oxygen, phosphorus and/or sulfur atom. Examples of the aryl ring may include phenyl, naphthyl, hexahydroindyl, indanyl, and tetrahydronaphthyl.

The polyazole-based material may have at least one amino group in the repeating unit described above. In this regard, the at least one amino group may be a primary, secondary or tertiary amino group as part of the aryl ring or substituent part of an aryl ring. The term “amino” includes compounds where a nitrogen atom is covalently bonded to at least one carbon or heteroatom. The term “amino” also includes —NH₂ and also includes substituted moieties.

The term also includes “alkyl amino” wherein the nitrogen is bound to at least one additional alkyl group. The term also includes “arylamino” and “diarylamino” groups wherein the nitrogen is bound to at least one or two independently selected aryl groups, respectively.

Methods of preparing the polyazole-based material and a polymer film including the polyazole-based material are disclosed in US 2005/256296A.

According to an embodiment of the present invention, the polyazole-based material may include a polymer represented by Formulae 41 through 54 below.

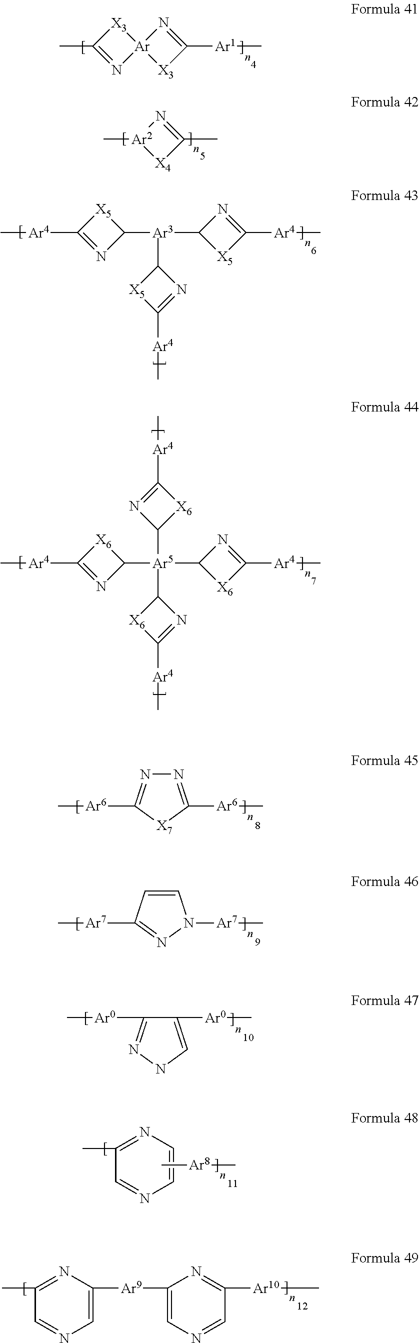

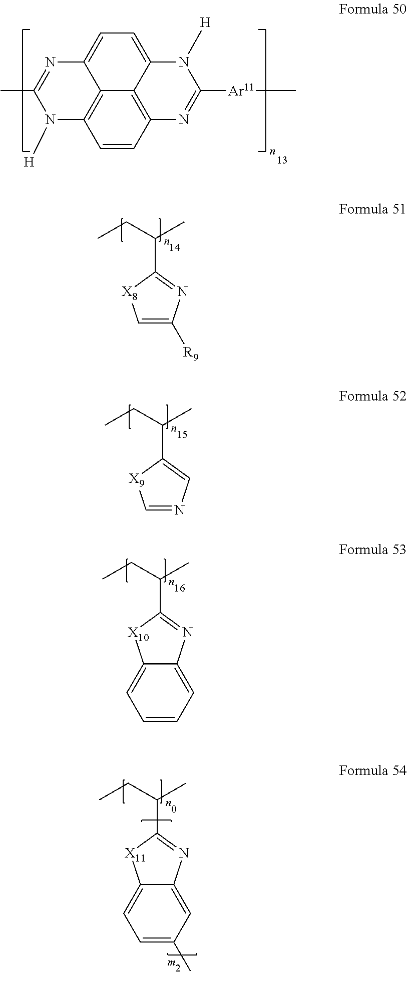

In Formulae 41 through 54, the substituents identified generically as Ar may be Ar, or Ar⁰ through Ar¹¹. Each such Ar may be identical to or different from each other such Ar, and may be a bivalent monocyclic or polycyclic C₆-C₂₀ aryl group or C₂-C₂₀ heteroaryl group;

X₃ through X₁₁ may be identical to or different from each other, and may be an oxygen atom, a sulfur atom or —N(R′); and R′ may be a hydrogen atom, a C₁-C₂₀ alkyl group, a C₁-C₂₀ alkoxy group, or a C₆-C₂₀aryl group;

R₉ may be identical to or different from each other, and may be a hydrogen atom, a C₁-C₂₀ alkyl group or a C₆-C₂₀ aryl group; and

n₀, n₄ through n₁₆ and m₂ are each independently an integer of 10 or greater, for example, an integer of 100 or greater, such as in the range of 100 to 100,000.

Examples of the aryl or heteroaryl group include benzene, naphthalene, biphenyl, diphenylether, diphenylmethane, diphenyldimethylmethane, bisphenone, diphenylsulfone, quinoline, pyridine, bipyridine, pyridazine, pyrimidine, pyrazine, triazine, tetrazine, pyrrole, pyrazole, anthracene, benzopyrrole, benzotriazole, benzoxathiazole, benzoxadiazole, benzopyridine, benzopyrazine, benzopyrazidine, benzopyrimidine, benzotriazine, indolizine, quinolizine, pyridopyridine, imidazopyrimidine, pyrazinopyrimidine, carbazole, aziridine, phenazine, benzoquinoline, phenoxazine, phenothiazine, acridizine, benzopteridine, phenanthroline and phenanthrene, wherein these aryl or heteroaryl groups may have a substituent.

Ar⁰, Ar, Ar¹, Ar⁴, Ar⁶, Ar⁷, Ar⁸, Ar⁹, Ar¹⁰, and Ar¹¹ defined above may have any substitutable pattern. For example, if Ar⁰, Ar, Ar¹, Ar⁴, Ar⁶, Ar⁷, Ar⁸, Ar⁹, Ar¹⁰ and Ar¹¹ are phenylene, Ar⁰, Ar, Ar¹, Ar⁴, Ar⁶, Ar⁷, Ar⁸, Ar⁹, Ar¹⁰ and Ar¹¹ may be ortho-phenylene, meta-phenylene or para-phenylene.

The alkyl group may be a C₁-C₄ short-chain alkyl group, such as methyl, ethyl, n-propyl, i-propyl or t-butyl. The aryl group may be, for example, a phenyl group or a naphthyl group.

Examples of the substituent include a halogen atom, such as fluorine, an amino group, a hydroxy group, and a short-chain alkyl group, such as methyl or ethyl.

Examples of the polyazole-based material include polyimidazole, polybenzothiazole, polybenzoxazole, polyoxadiazole, polyquinoxaline, polythiadiazole, polypyridine, polypyrimidine, and polytetrazapyrene.

The polyazole-based material may be a copolymer or blend including at least two units selected from the group consisting of units represented by Formulae 41 through 54 above. The polyazole-based material may be a block copolymer (di-block or tri-block), a random copolymer, a periodic copolymer or an alternating polymer including at least two units selected from the units of Formulae 41 through 54.

A polyazole-based material including only the unit of Formulae 41 and/or 42 may be used. An example of the polyazole-based material may include a polymer represented by Formulae 14 through 40.

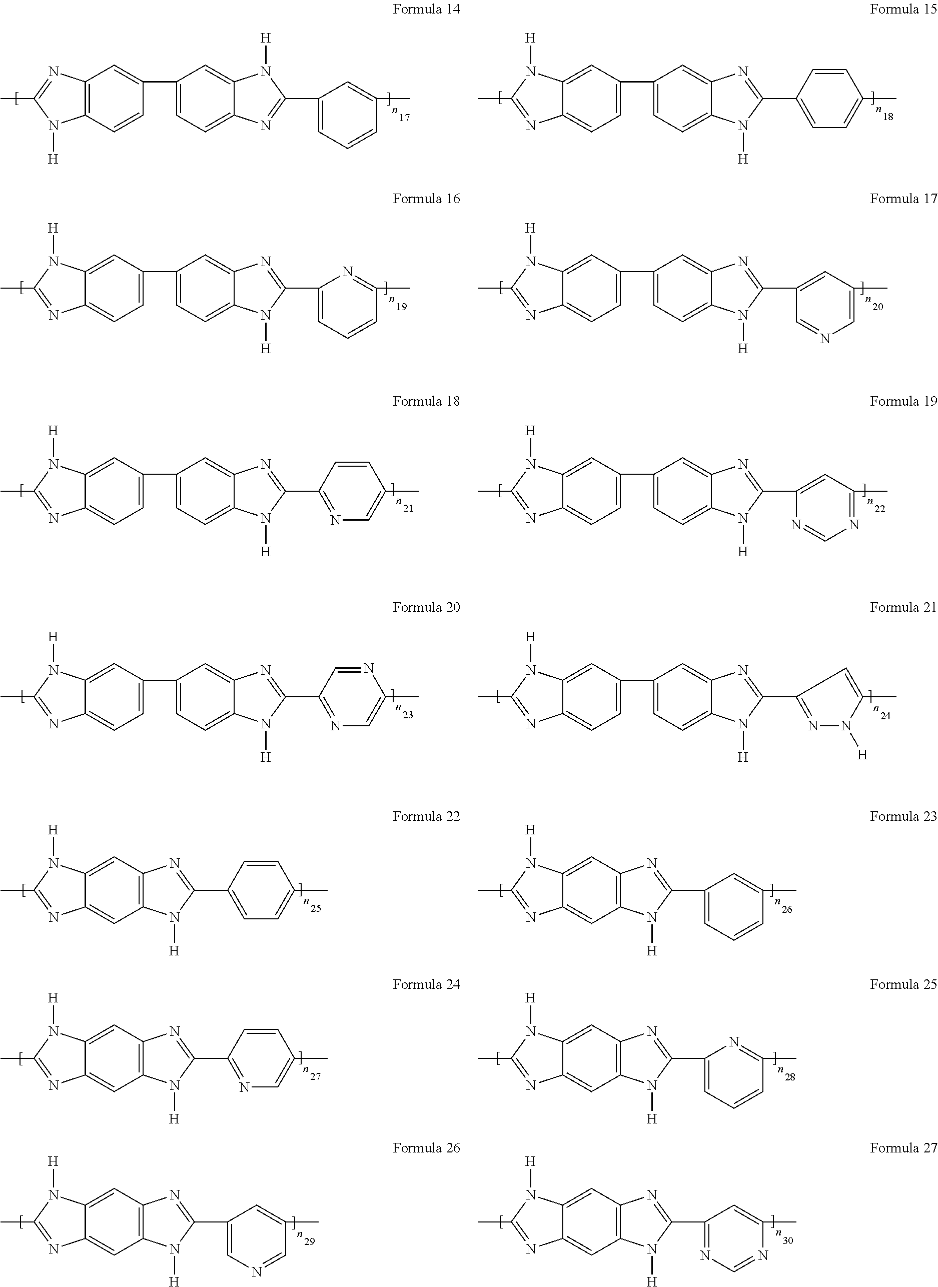

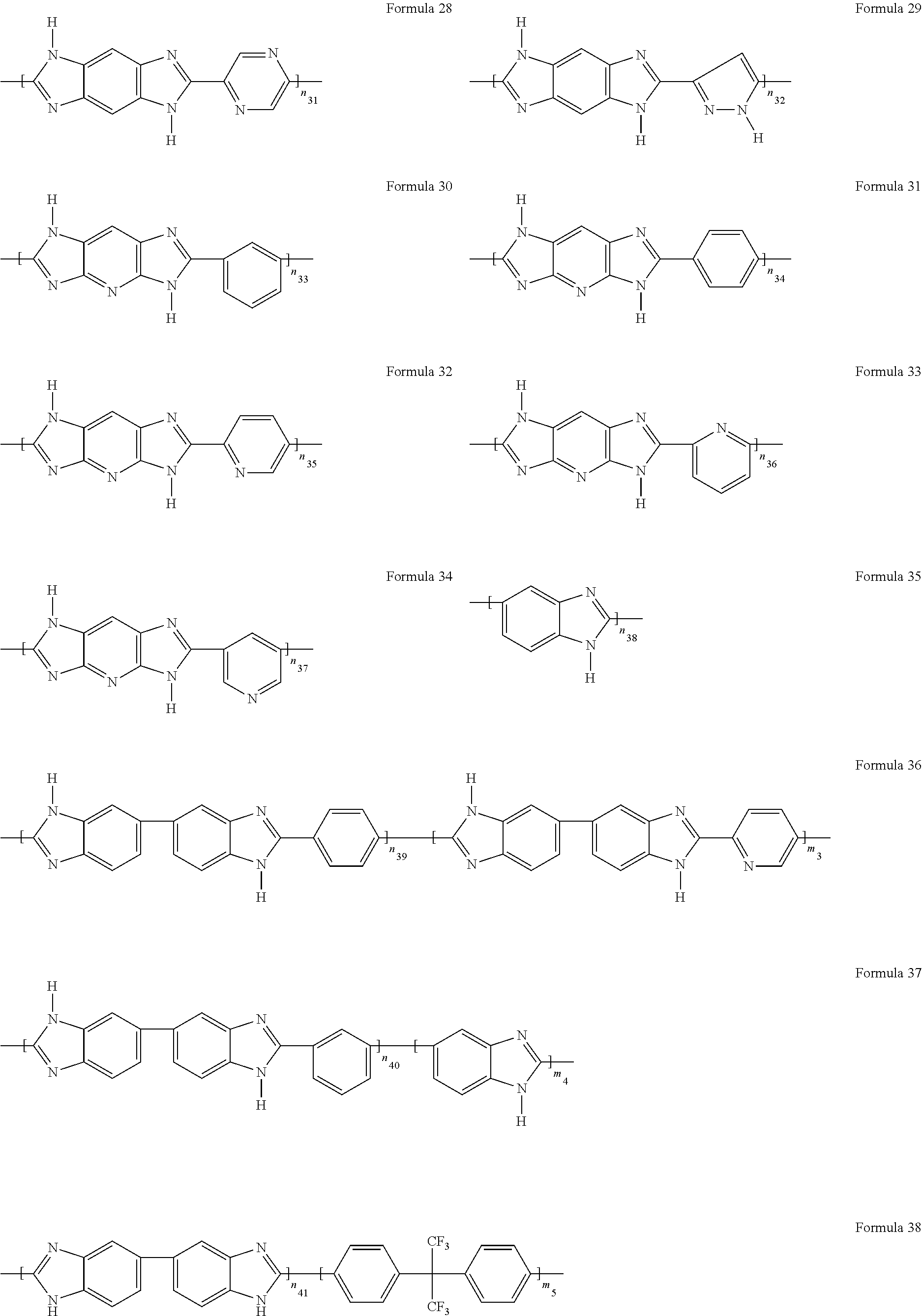

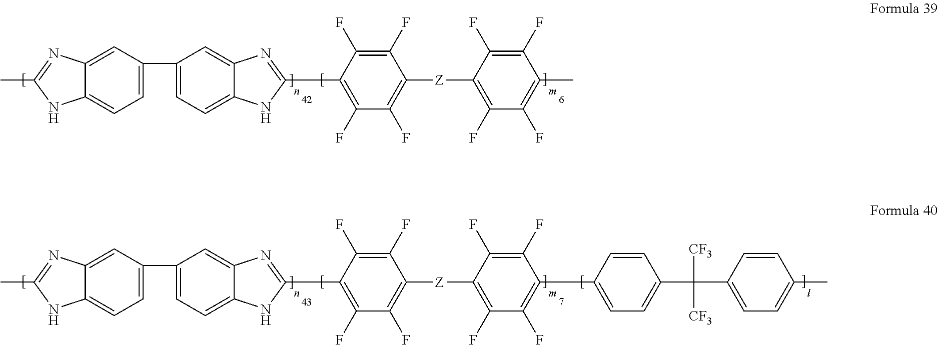

In Formulae 14 through 40, l, n₁₇ through n₄₃, and m₃ through m₇ are each independently an integer of 10 or greater, for example, an integer of 100 or greater; and z indicates chemical bonding, or —(CH₂)ₛ—, —C(═O)—, —SO₂—, —C(CH₃)₂— or —C(CF₃)₂—, and s is an integer of 1 to 5.

The aromatic and/or heteroaromatic carboxylic acid may be a C₄-C₃₀ compound, and may be represented by, for example, Formula 4 or 5.

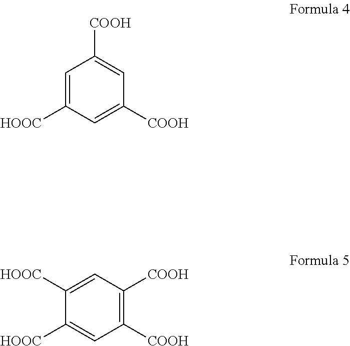

The compound represented by Formula 1 and having an amino group at a terminal thereof and at least one amino group in a repeating unit and the carboxylic acid compound are dissolved in a solvent, and are heat-treated together with polyphosphoric acid at a heat-treatment temperature of about 60 to about 250° C. so that a cross-linking reaction may proceed to obtain a cross-linked diamine-terminated polyazole-based material.

The solvent may be dimethylacetamide, dimethylformamide, dimethylsulfoxide, methylpyrrolidone or the like. The amount of the solvent may be in the range of about 500 to about 10,000 parts by weight based on 100 parts by weight of the aromatic and/or heteroaromatic carboxylic acid. When the amount of the solvent is within this range, reactivity of the cross-linking reaction may be excellent.

An amount of the polyphosphoric acid may be in the range of about 1000 to about 10,000 parts by weight based on 100 parts by weight of the aromatic and/or heteroaromatic carboxylic acid compound. When polyphosphoric acid is within this range, the cross-linked material may be obtained with a high yield.

When the heat-treatment temperature of the above reaction is within this range, the cross-linked diamine-terminated polyazole-based material may be obtained with a high yield.

Reaction Scheme 1 below represents a process of preparing a cross-linked material according to an embodiment of the present invention.

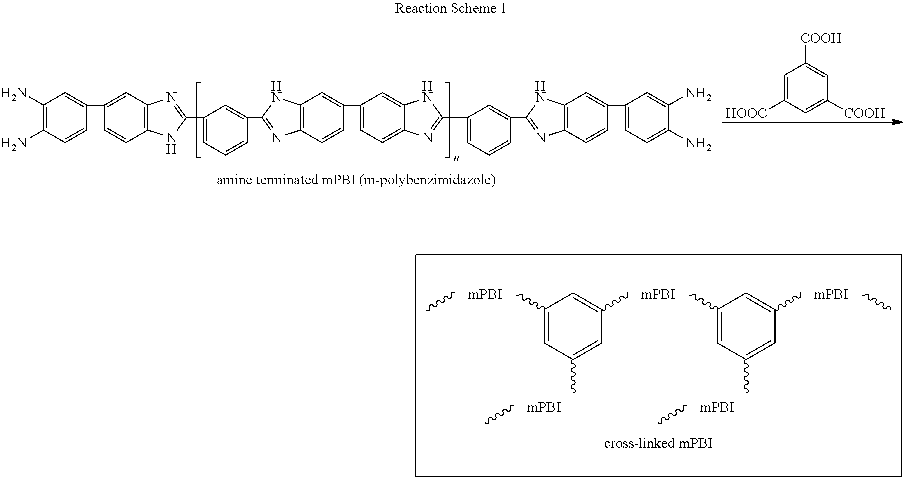

In Reaction Scheme 1, n is a number of 1 through 300.

According to an embodiment of the present invention, the cross-linked material may have a unit represented by Formula 6 or 7 below.

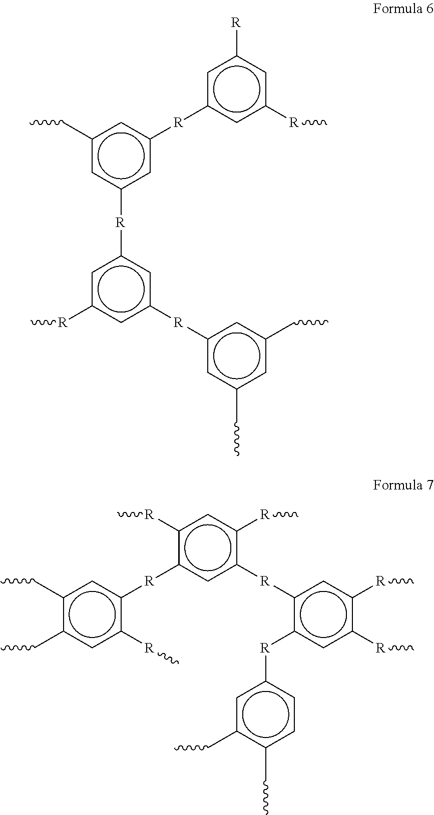

In Formulae 6 and 7 above, R is selected from the groups represented by Formulae 14 through 40 above.

Formulae 6 and 7 represent a portion of the cross-linked material. In Formulae 6 and 7, the [symbol] indicates structure omitted from the diagram.

The cross-linked material may be represented by Formula 3A below.

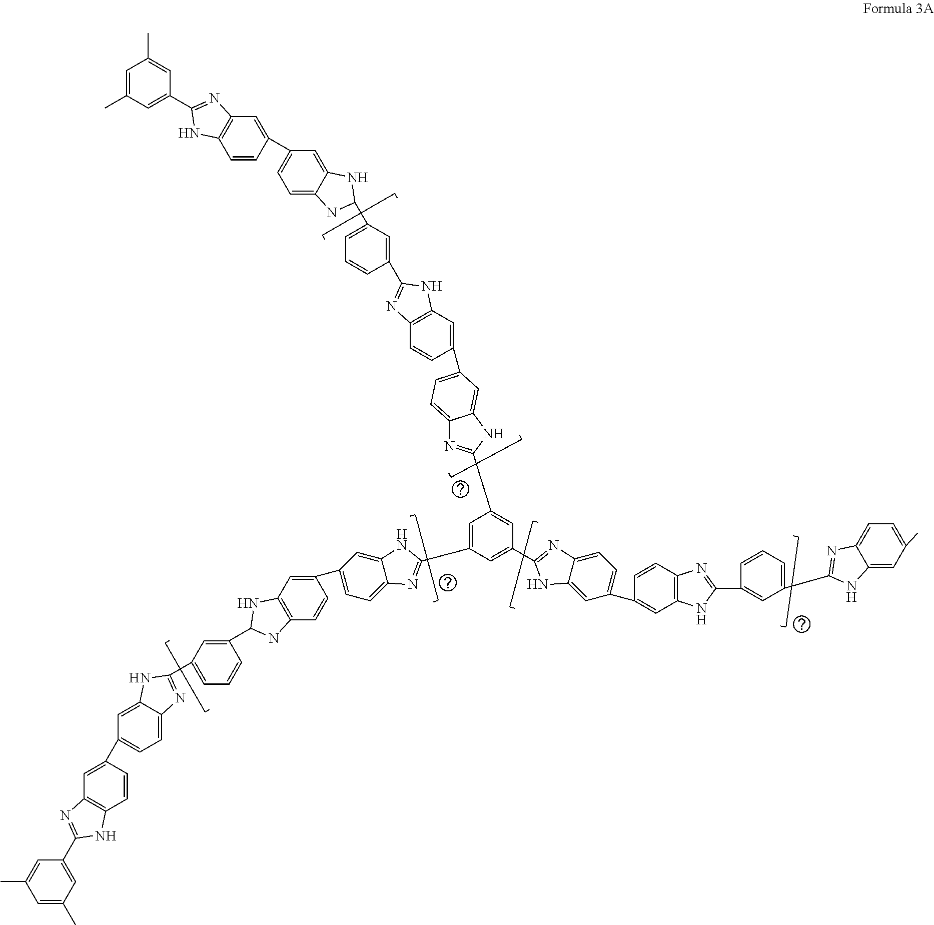

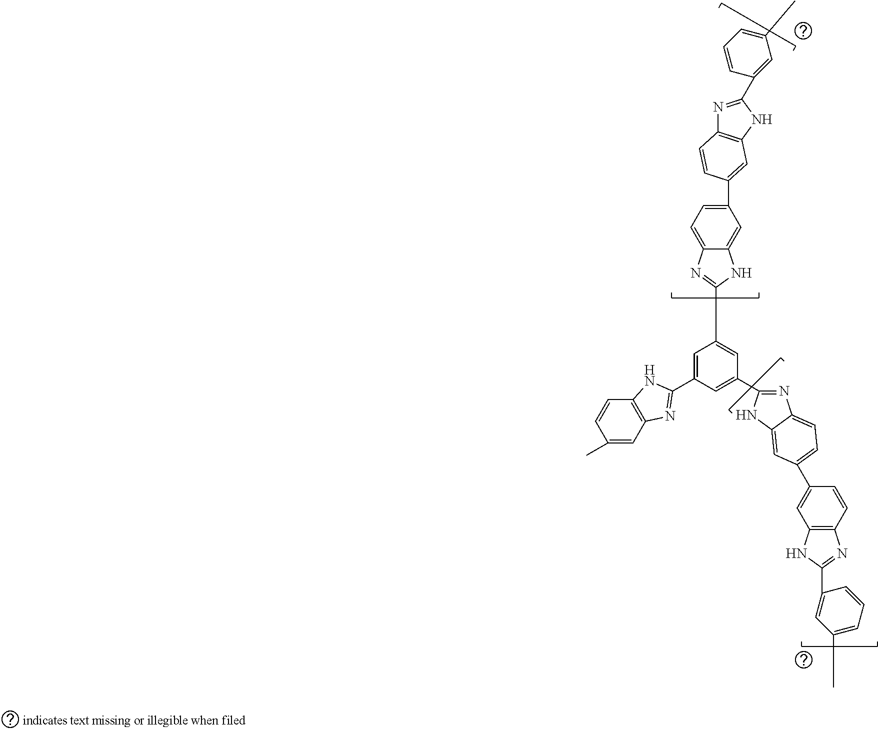

In Formula 3A, n is a number from 1 to 300.

In addition, the compound represented by Formula 1 and having an amino group at a terminal thereof and at least one amino group in a repeating unit provides a reaction product obtained by performing heat-treatment at a heat-treatment temperature of about 60 to about 250° C.

When the heat-treatment temperature is within this range, the reaction product may be obtained with a high yield.

The cross-linked material may be polymerized with an oxazine-based monomer to prepare a double cross-linked polymer derived from the cross-linked material.

The oxazine-based monomer may be at least one selected from the group consisting of compounds represented by Formulae 8 through 13 below, but are not limited thereto.

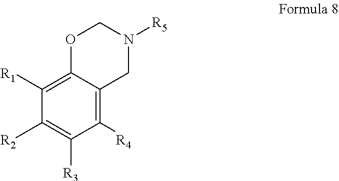

In Formula 8, R₁ through R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, a halogen atom, a hydroxy group, or a cyano group; and

R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group.

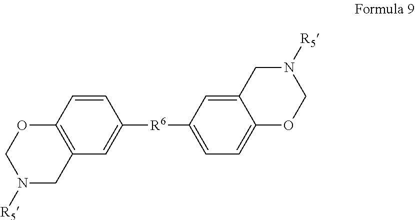

In Formula 9, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and

R₆ is selected from the group consisting of a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, and —SO₂—.

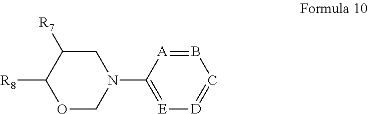

In Formula 10, A, B, C, D and E are all carbon; or one or two of A, B, C, D and E is nitrogen and the others are carbon,

R₇ and R₈ are linked to form a ring, and the ring is a C₆-C₁₀ cycloalkyl group, a C₃-C₁₀ heteroaryl group, a fused C₃-C₁₀ heteroaryl group, a C₃-C₁₀ heterocyclic group or a fused C₃-C₁₀ heterocyclic group.

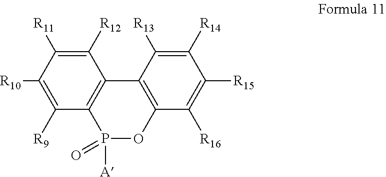

In Formula 11, A′ is a substituted or unsubstituted C₁-C₂₀ heterocyclic group, a substituted or unsubstituted C₄-C₂₀ cycloalkyl group, or a substituted or unsubstituted C₁-C₂₀ alkyl group; and

R₉ through R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group.

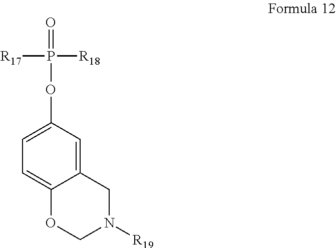

In Formula 12, R₁₇ and R₁₈ are each independently a C₁-C₂₀ alkyl group, a C₁-C₂₀ alkoxy group, a C₆-C₂₀ aryl group, a C₆-C₂₉ aryloxy group or a group represented by Formula 12A below.

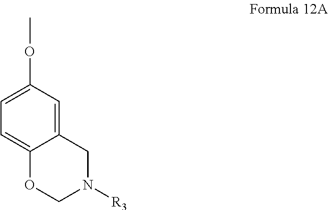

In Formulae 12 and 12A, R₁₉ and R_{19′} are each a hydrogen atom, a C₁-C₂₀ alkyl group, a C₁-C₂₀ alkoxy group, a C₆-C₂₀ aryl group, a C₈-C₂₀ aryloxy group, a halogenated C₁-C₂₀ aryl group, a halogenated C₈-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group or a halogenated C₁-C₂₀ heterocyclic group.

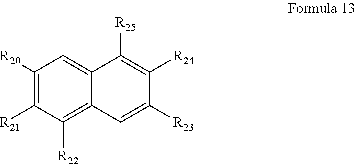

In Formula 13, at least two adjacent groups selected from among R₂₀, R₂₁ and R₂₂ are linked to form a group represented by Formula 13A below, and the non-selected, remaining group is a hydrogen atom, a C₁-C₂₀ alkyl group, a C₁-C₂₀ alkoxy group, a C₆-C₂₀ aryl group, a C₆-C₂₀ aryloxy group, a halogenated C₅-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group; and

At least two adjacent groups selected from among R₂₃, R₂₄ and R₂₅ are linked to form the group represented by Formula 13A below, and the non-selected, remaining group is a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group.

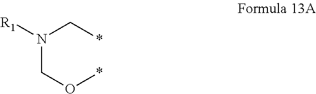

In Formula 13A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group; and

* denotes the sites at which the at least two adjacent groups selected from among R₂₀, R₂₁ and R₂₂ of Formula 13 and the at least two adjacent groups selected from among R₂₃, R₂₄ and R₂₅ are linked, respectively.

In Formula 13A, R₁′ is selected from the groups represented by Formula 13B below.

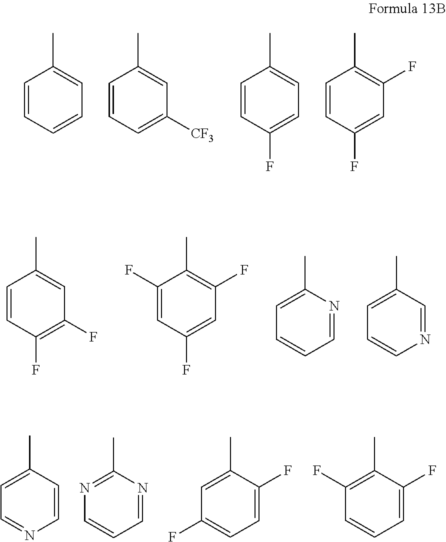

Examples of the oxazine-based monomer of Formula 8 may include compounds represented by Formulae 55 through 103 below.

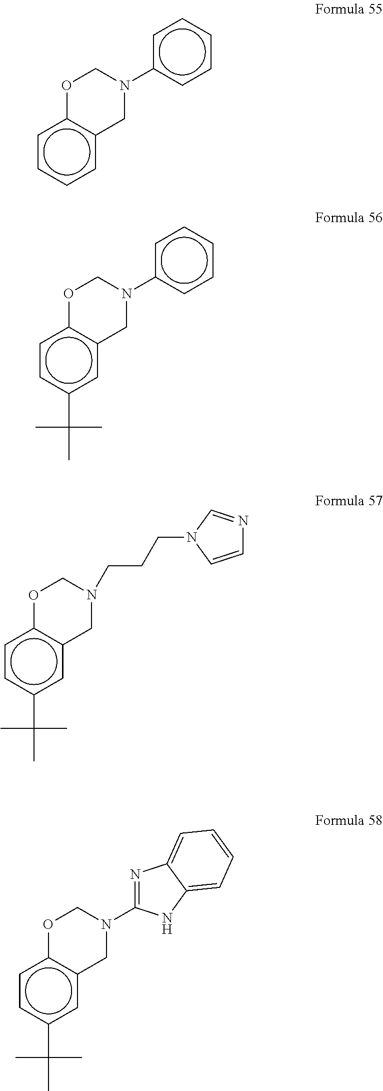

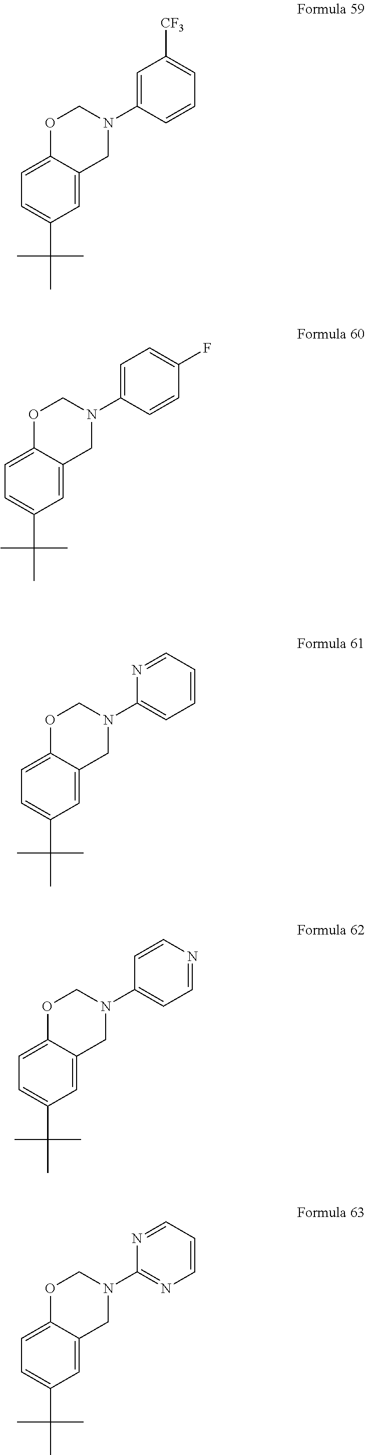

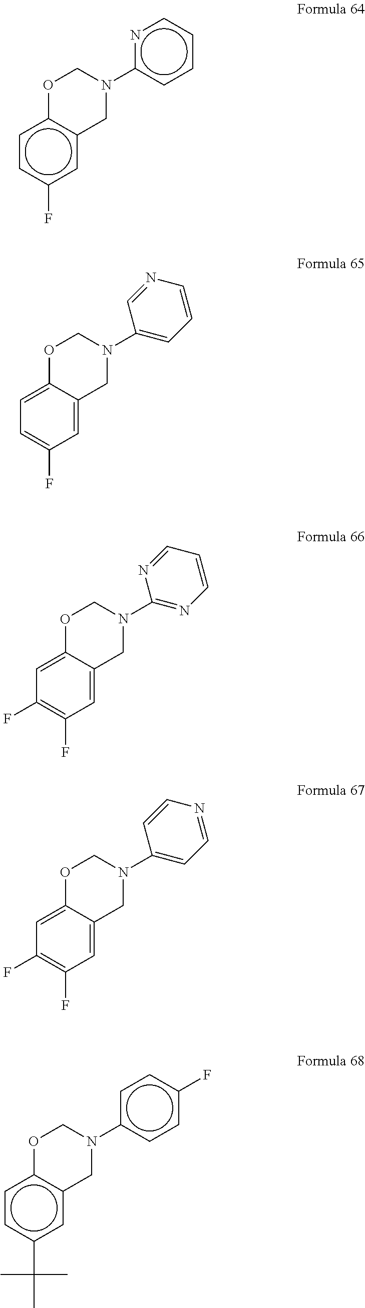

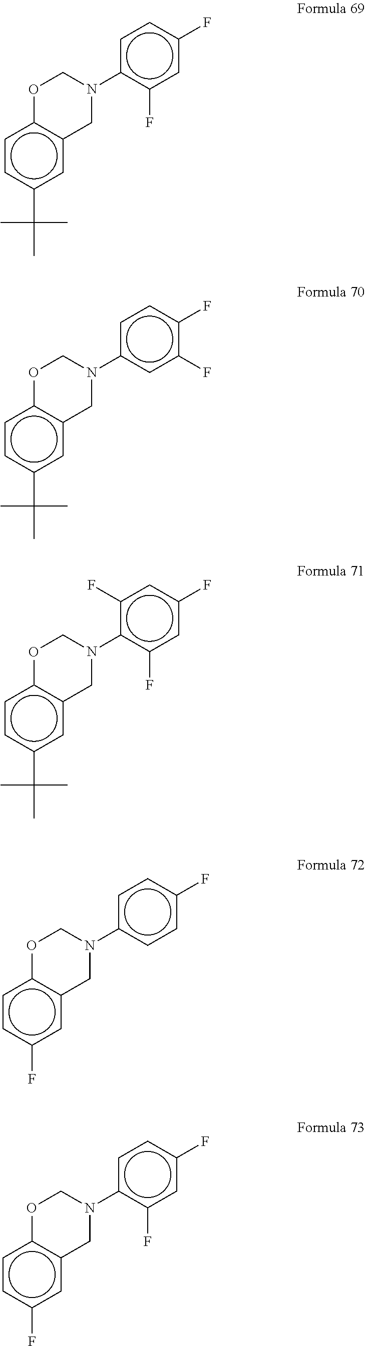

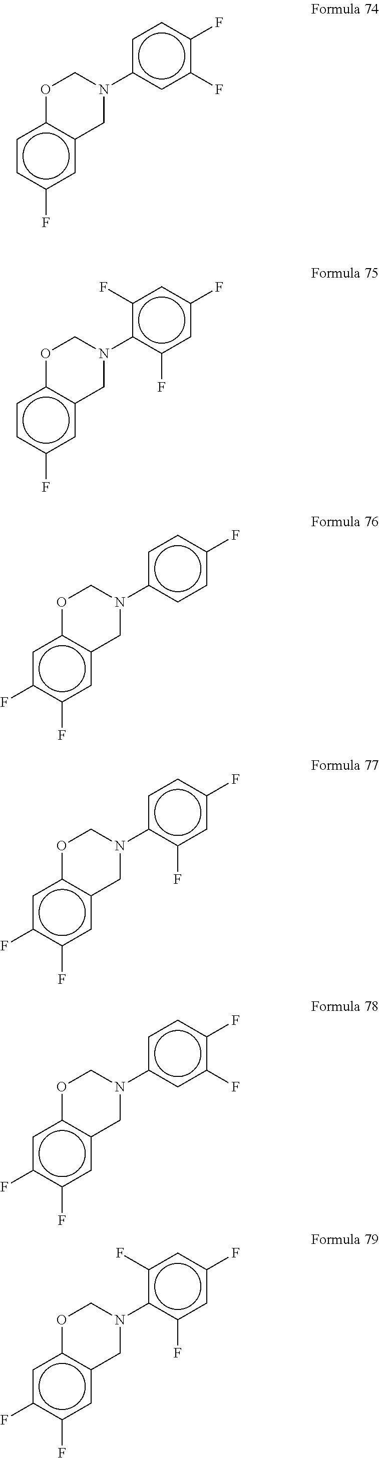

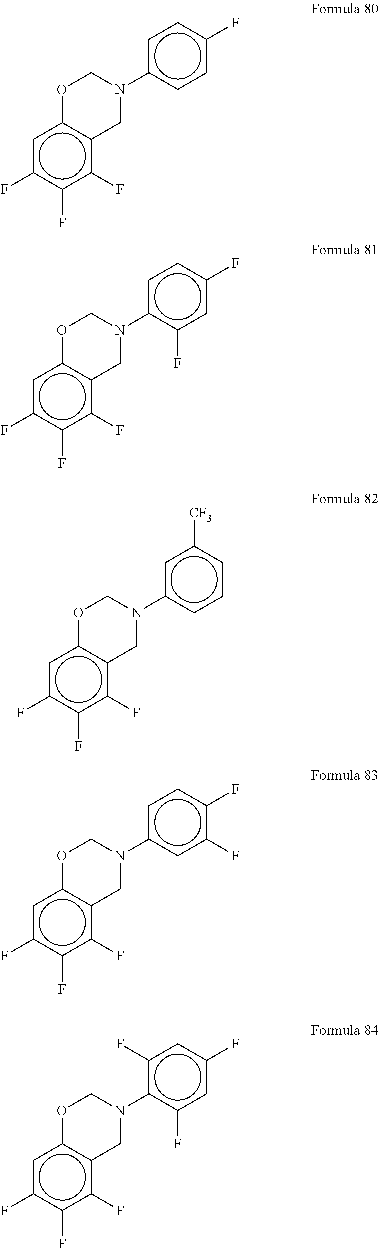

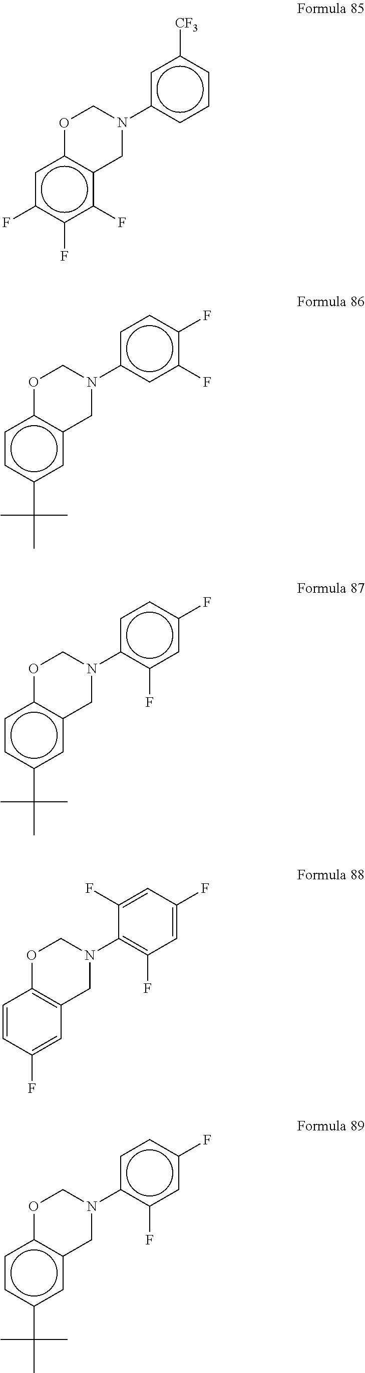

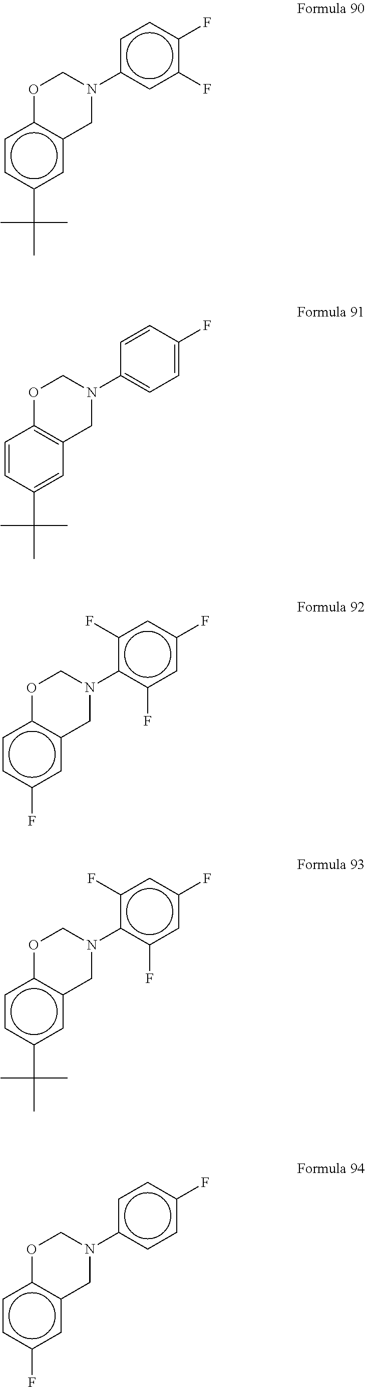

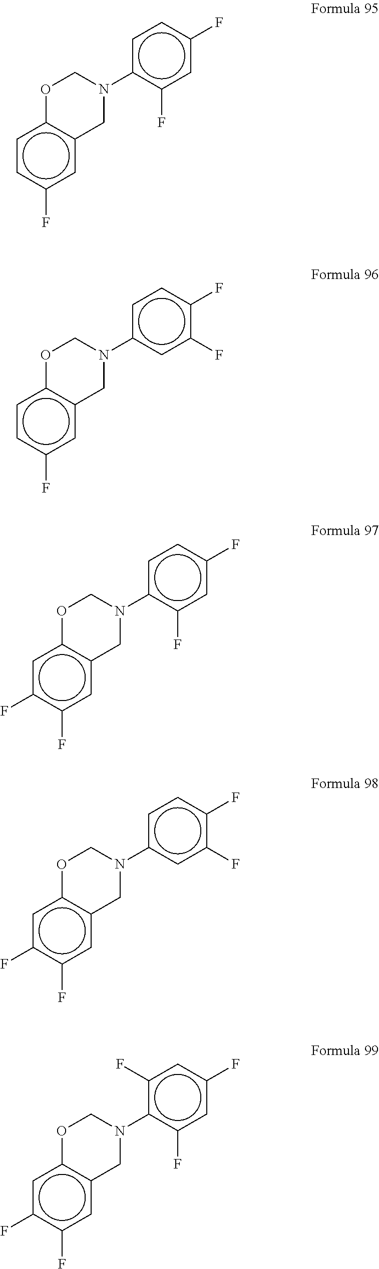

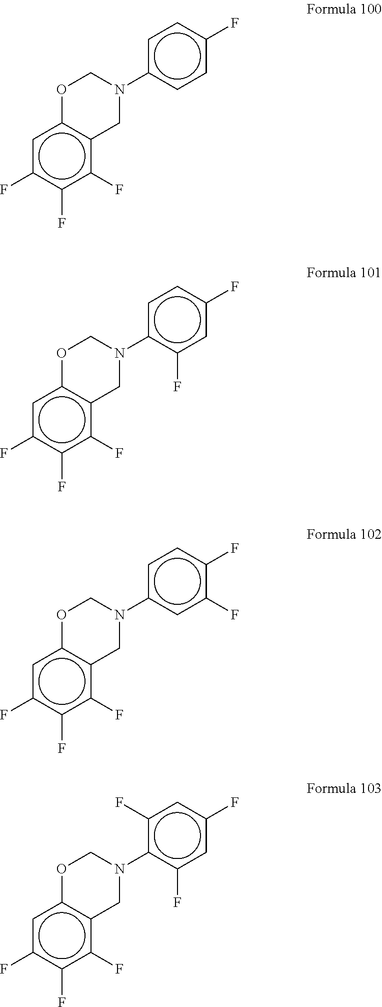

Examples of the oxazine-based monomer of Formula 9 may include compounds represented by Formulae 104 through 108 below.

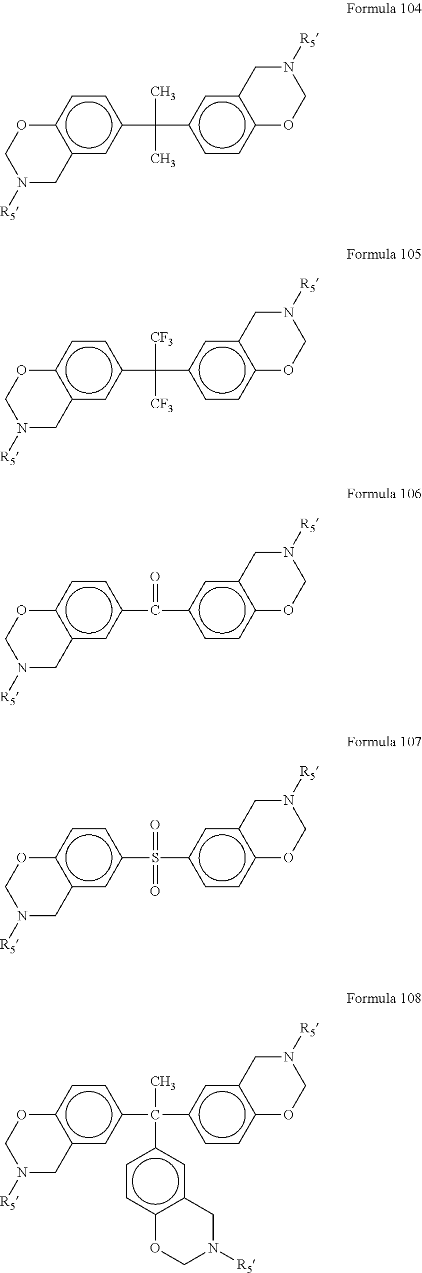

In Formulae 104 through 108, R₅ is —CH₂—CH═CH₂, or one of the groups represented by Formula 109 below:

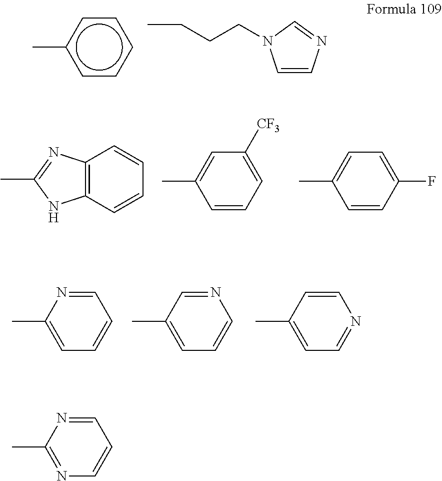

Examples of the compound of Formula 9 may be selected from the compounds represented by Formulae 110 through 113 below:

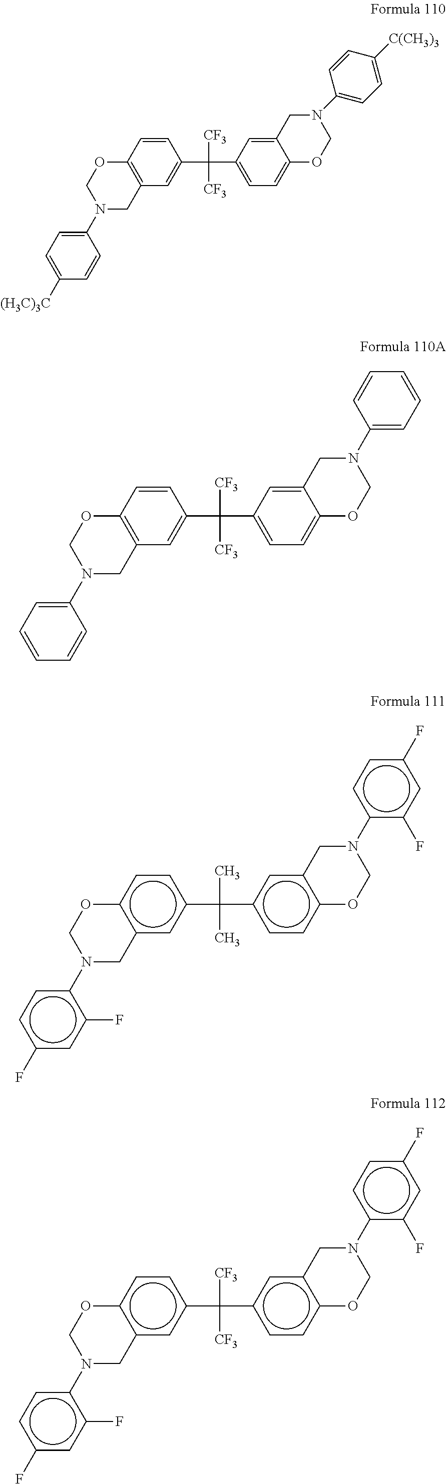

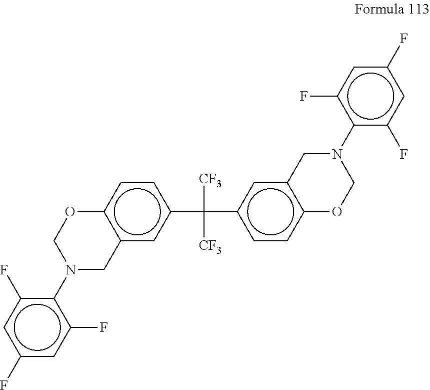

Examples of the oxazine-based monomer of Formula 10 may include compounds represented by Formulae 114 through 117 below.

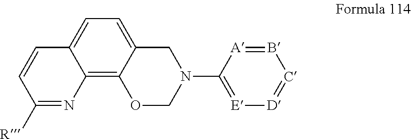

In Formula 114, R′″ is a hydrogen atom or a C₁-C₁₀ alkyl group.

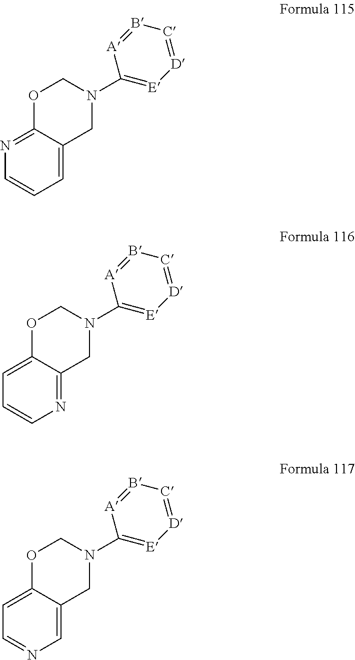

In Formulae 114 through 117 above,

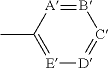

is selected from the group represented from Formula 118 below.

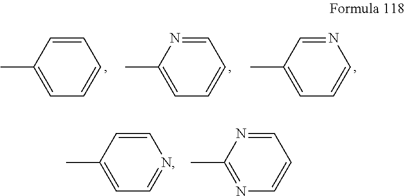

Examples of the oxazine-based monomer of Formula 10 may include compounds represented by Formulae 119 through 139 below.

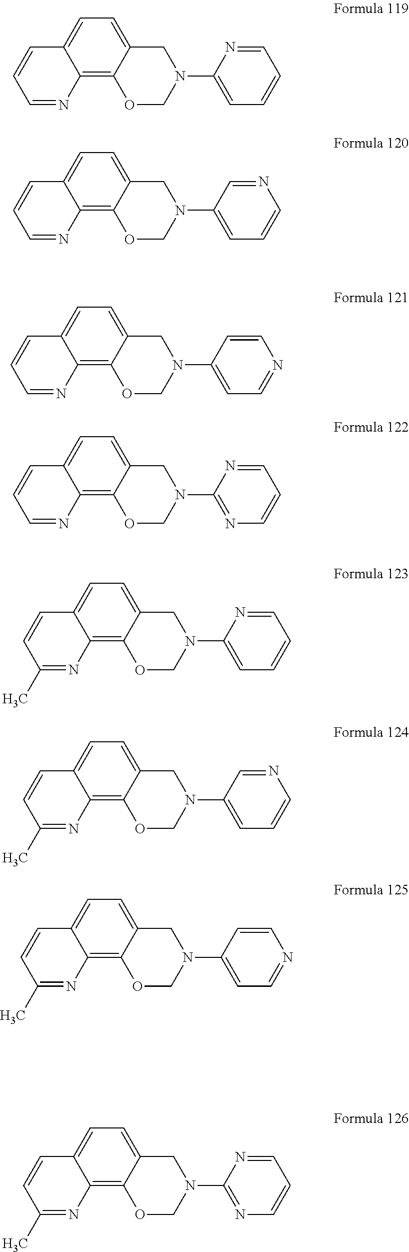

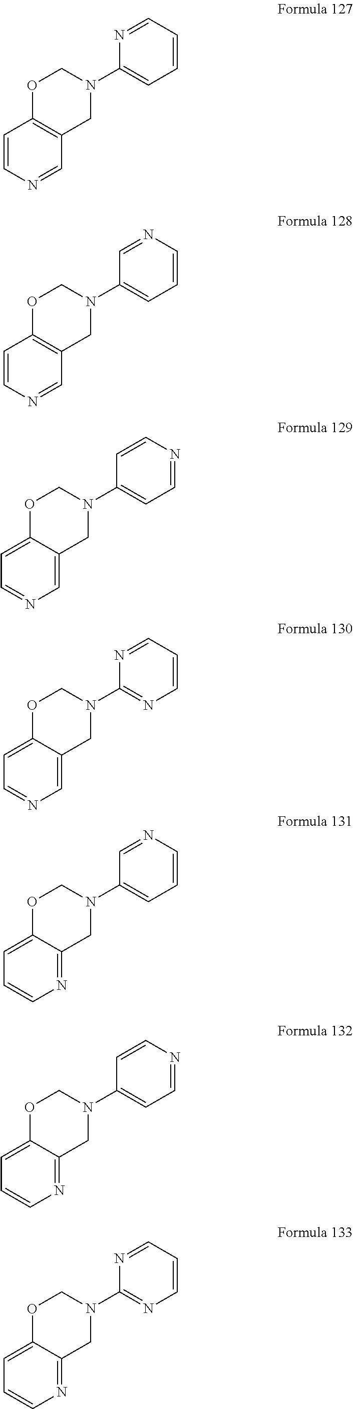

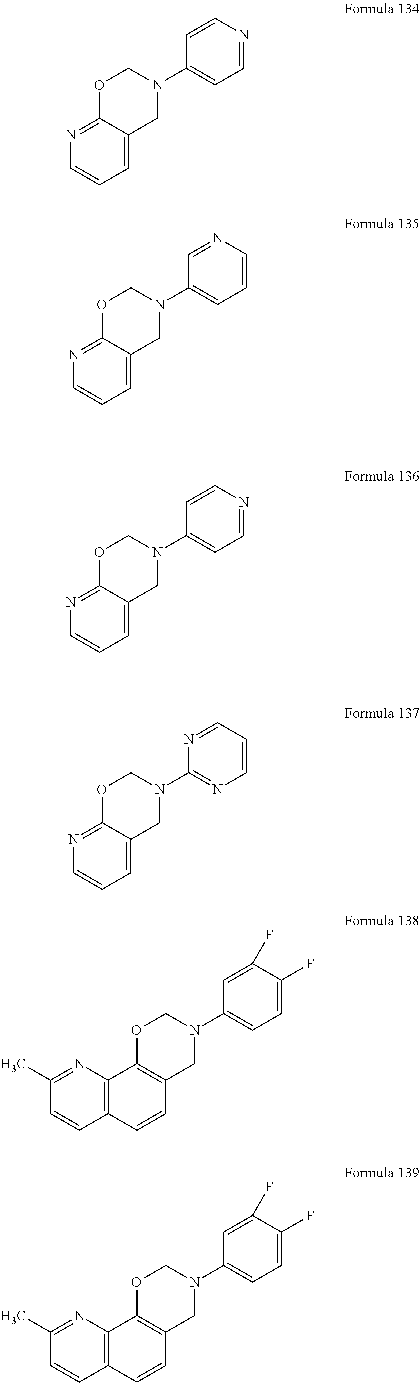

In Formula 11, A′ may be selected from the groups represented by Formulae 140 and 141 below.

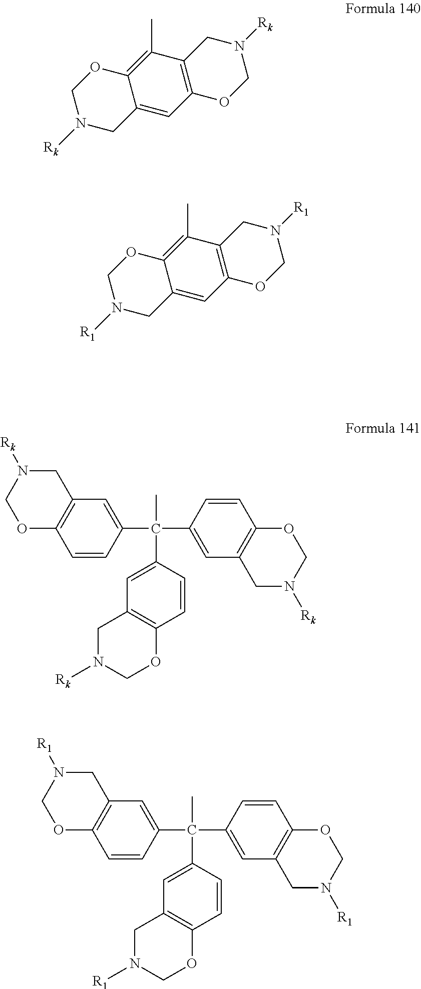

In Formulae 140 and 141, Rₖ is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group.

Examples of the compound of Formula 11 include compounds represented by Formula 142 or 143 below.

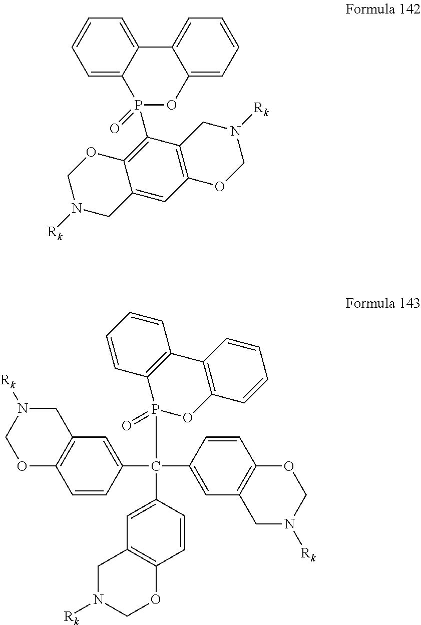

In Formulae 142 and 143, Rₖ may be selected from the groups represented by Formula 144 below.

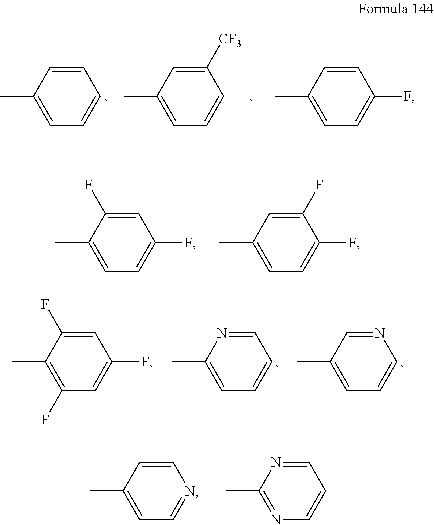

The compound of Formulae 11 above is selected from the compounds represented by Formulae 145 through 150 below:

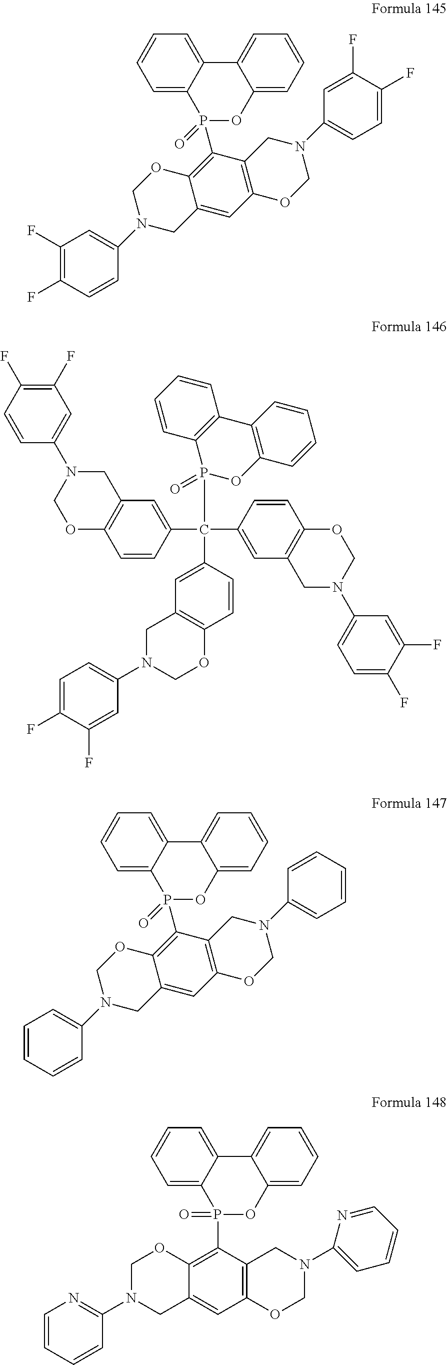

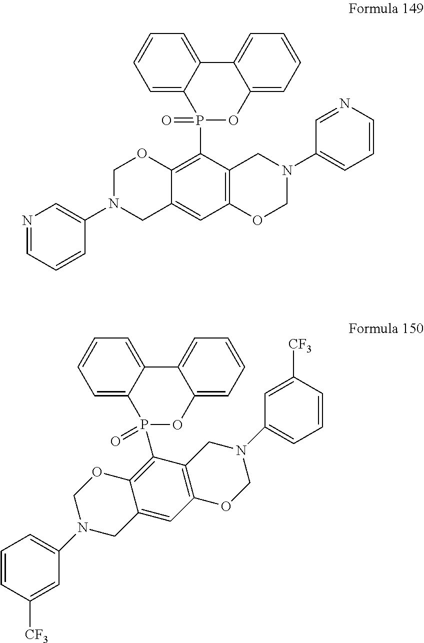

Examples of the compound of Formula 12 include compounds represented by Formula 151, 152 or 154 below.

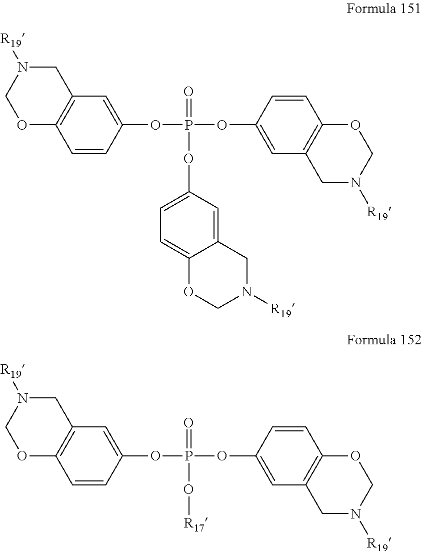

In Formulae 151 and 152, R₁₇′ is a C₁-C₁₀ alkyl group, a C₁-C₁₀ alkoxy group, a C₆-C₁₀ aryl group, or a C₆-C₁₀ aryloxy group; and R₁₉′ is selected from the groups represented by Formula 153 below:

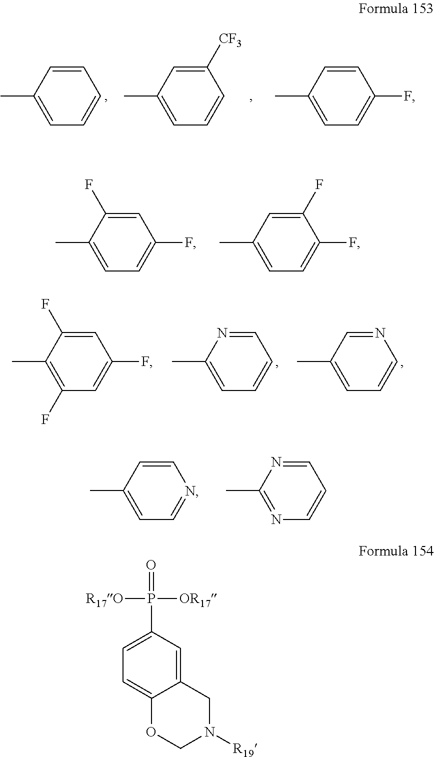

In Formula 154, R₁₇′ is a C₆-C₁₀ aryl group; and R₁₉″ is selected from the groups represented by Formula 155 below:

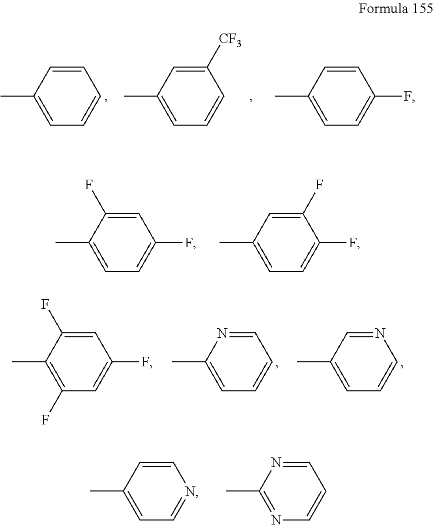

Examples of the compound of Formula 12 include compounds represented by

Formula 156 and 157 below:

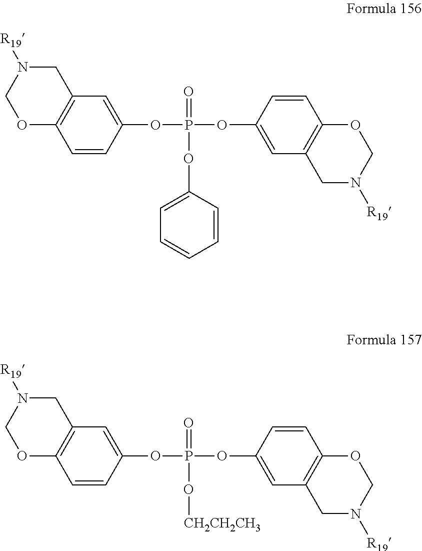

In Formulae 156 and 157, R₁₉′ is selected from the groups represented by Formula 158.

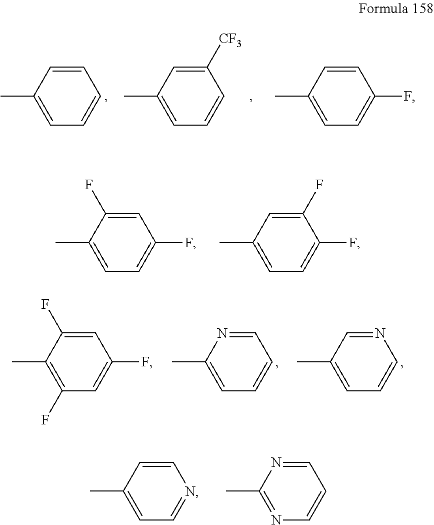

Examples of the compound of Formula 12 include compounds represented by Formulae 159 through 165.

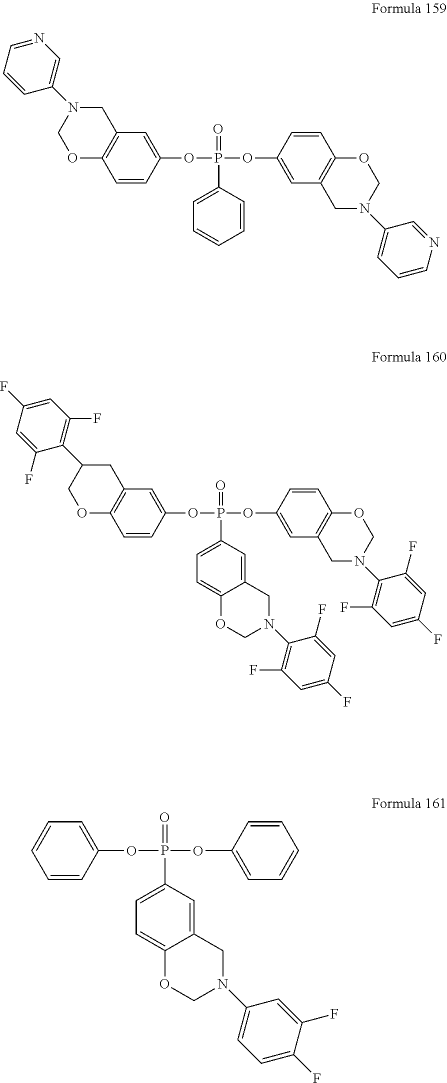

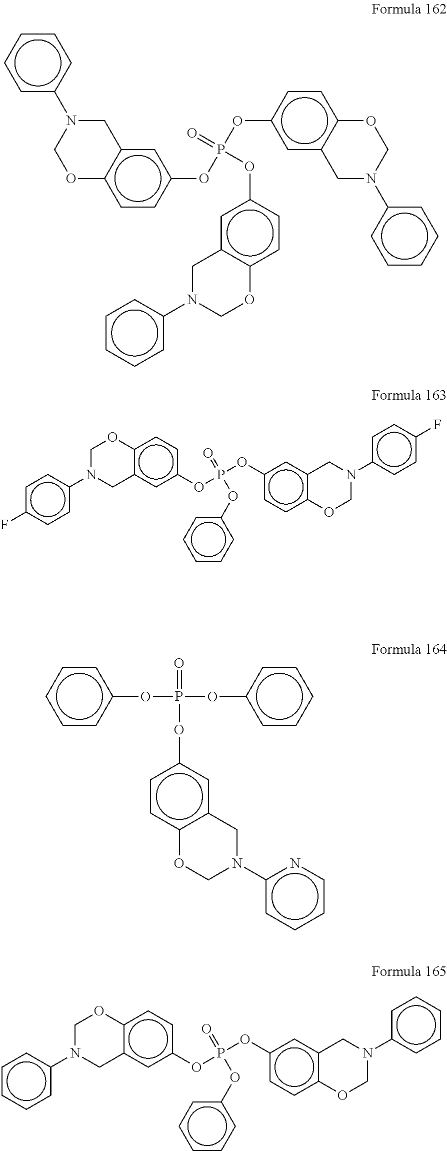

Examples of the compound of Formula 13 include compounds represented by Formulae 166 through 168 below.

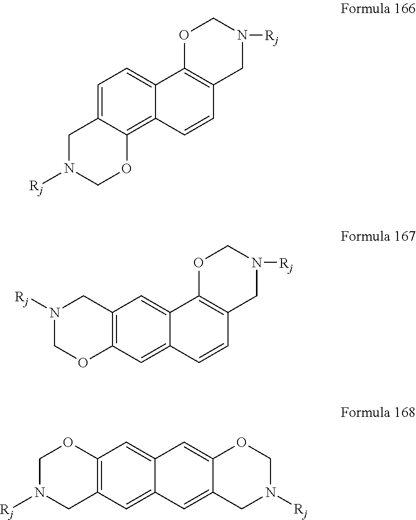

In Formulae 166 through 168, Rⱼ is selected from the groups represented by Formula 169 below.

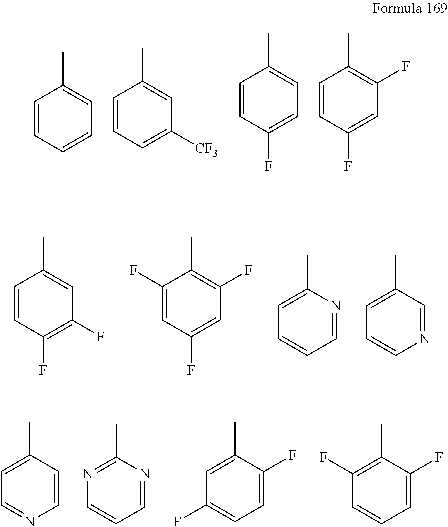

Examples of the compound of Formula 13 may include compounds represented by Formulae 170 through 177 below.

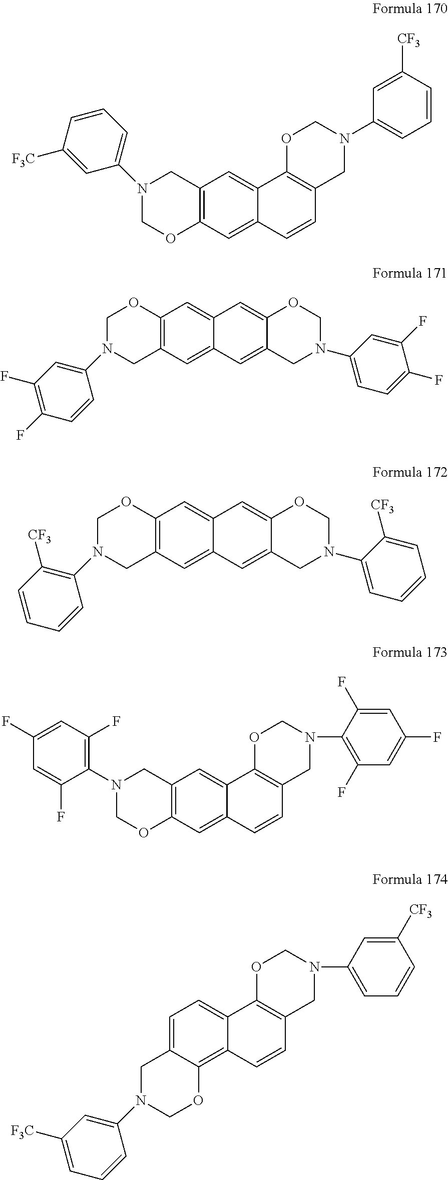

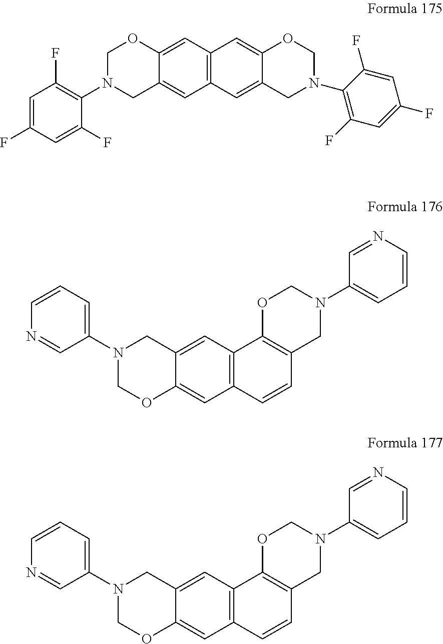

Examples of the oxazine-based monomer include compounds represented by Formula 162 below.

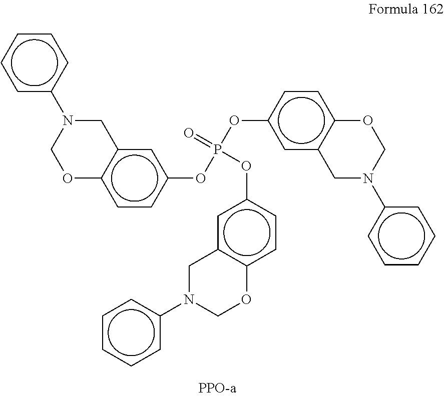

The amount of the oxazine-based monomer is in the range of about 1 to about 500 parts by weight, for example, about 10 to about 300 parts by weight based on 100 parts by weight of the cross-linked material of the compound. When the amount of the benzoxazine-based monomer is within this range, a double cross-linked polymer may have an increased amount of phosphoric acid and improved mechanical properties.

With regard to the double cross-linked polymer, when the cross-linked material reacts with an oxazine-based monomer, a polymerization reaction of the oxazine-based monomer may proceed, and the oxazine-based monomer and/or a polymer thereof may graft-polymerize with the cross-linked material to prepare a graft copolymer or to have a structure having a cross-linking bond.

A method of preparing an electrolyte membrane including the double cross-linked polymer derived from the cross-linked material will now be described.

The cross-linked material is mixed with polyphosphoric acid, an oxazine-based monomer is added to the mixture, and then the resultant is casted and heat-treated. The heat-treatment may be performed at a temperature of about 100 to 250° C.

The heat-treated product is impregnated with phosphoric acid at room temperature. The phosphoric acid may be 85 wt % ortho-phosphoric acid, or diluted to about 5 to about 30 wt % of aqueous phosphoric acid solution.

The heat-treated product may be left in a constant-temperature and constant-humidity condition before being impregnated with the phosphoric acid. In the constant-temperature and constant humidity condition, the polyphosphoric acid is hydrolyzed.

In the constant-temperature and constant-humidity condition, the temperature may be adjusted to a range of about −20 to about 30° C., and the relative humidity (RH) may be adjusted to a range of about 5 to about 50% RH.

According to an embodiment of the present invention, the temperature may be, for example, in the range of about −10° C. to about 15° C., and the relative humidity may be, for example, in the range of about 5 to about 25%. Alternatively, the heated-treated product may be left at −10° C. and 25% RH for 48 hours or longer to induce slow hydrolysis of the polyphosphoric acid.

When the temperature is within the above range, the hydrolysis rate may be controlled without a reduction in hydrolytic reactivity of the polyphosphoric acid. When the relative humidity is within the above range, the electrolyte membrane may have excellent physical properties without a reduction in hydrolytic reactivity of the polyphosphoric acid.

The reaction product is dried in a vacuum at room temperature (20° C.) to obtain the electrolyte membrane for a fuel cell, including the double cross-linked polymer.

When an electrolyte membrane is prepared by using a cross-linked material of the compound of Formula 1, the same method is used as the above-described method of preparing the electrolyte membrane including the double cross-linked polymer derived from the cross-linked material, except that the cross-linked material for the compound of Formula 1 was used, instead of the cross-linked material and the oxazine-based monomer.

The electrolyte membrane may have increased storage capacity of phosphoric acid and improved mechanical properties. The electrolyte membrane may be used in a high-temperature fuel cell. The electrolyte membrane using the double cross-linked polymer may be prepared using a sol-gel method using the cross-linked material of the compound of Formula 1 together with polyphosphoric acid, as described above. Alternatively, the electrolyte membrane may be prepared by mixing the cross-linked material of the compound of Formula 1 and the oxazine-based monomer, adding a solvent such as dimethylacetamide, if necessary, and then heat-treating the mixture. For example, the electrolyte membrane may be prepared using a method of preparing an electrolyte membrane including oxazine-based monomer, and polybenzimidazole as a cross-linkable compound, which is disclosed in U.S. Patent Application Publication No. 20090117436.

According to an embodiment of the present invention, an electrode for a fuel cell includes the cross-linked material produced by heat-treating the cross-linked material of the compound of Formula 1 or the double cross-linked polymer, and a catalyst.

The catalyst may be platinum (Pt), an alloy or a mixture of platinum (Pt) and at least one metal selected from the group consisting of gold (Au), palladium (Pd), rhodium (Ru), iridium (Ir), ruthenium (Ru), tin (Sn), molybdenum (Mo), cobalt (Co), and chromium (Cr). The Pt, the alloy, or the mixture may be supported on a carbonaceous support. For example, the catalyst may be at least one metal selected from the group consisting of Pt, a Pt/Co alloy, and a Pt/Ru alloy. Such a metal may be supported on a carbonaceous support.

The electrode may further include a binder conventionally used in the manufacture of an electrode for a fuel cell.

The binder may be at least one of poly(vinylidenefluoride), polytetrafluoroethylene, a tetrafluoroethylene-hexafluoroethylene copolymer, and perfluoroethylene. The amount of the binder may be in the range of about 0.001 to about 0.5 parts by weight based on 1 part by weight of the catalyst. When the amount of the binder is within this range, a catalyst layer may have strong binding ability to the support.

In the electrode for a fuel cell, oxygen permeation may be improved even when air is used in a cathode, and wettability with phosphoric acid (H₃PO₄) in the electrode and thermal stability may also be improved. Thus, a fuel cell including the electrode and the electrolyte membrane described above may operate in high-temperature, non-humidified conditions, and may have improved thermal stability and power generation capacity. Substituents in the formulae above may be defined as follows.

As used herein, the term “alkyl” refers to a fully saturated branched or unbranched (or straight chain or linear) hydrocarbon moiety.

Examples of the alkyl group used herein include, but are not limited to, methyl, ethyl, n-propyl, iso-propyl, n-butyl, sec-butyl, iso-butyl, tert-butyl, n-pentyl, isopentyl, neopentyl, n-hexyl, 3-methylhexyl, 2,2-dimethylpentyl, 2,3-dimethylpentyl, and n-heptyl.

At least one hydrogen atom of the alkyl group may be substituted with a halogen atom, a C₁-C₂₀ alkyl group substituted with a halogen atom (for example, CCF₃, CHCF₂, CH₂F and CCl₃), a C₁-C₂₀ alkoxy, a C₂-C₂₀ alkoxyalkyl, a hydroxy group, a nitro group, a cyano group, an amino group, an amidino group, a hydrazine, a hydrazone, a carboxyl group or a salt thereof, a sulfonyl group, a sulfamoyl, a sulfonic acid group or a salt thereof, a phosphoric acid or a salt thereof, a C₁-C₂₀ alkyl group, a C₂-C₂₀ alkenyl group, a C₂-C₂₀ alkynyl group, a C₁-C₂₀ heteroalkyl group, a C₆-C₂₀ aryl group, a C₆-C₂₀ arylalkyl group, a C₆-C₂₀ heteroaryl group, a C₇-C₂₀ heteroarylalkyl group, a C₆-C₂₀ heteroaryloxy group, a C₆-C₂₀ heteroaryloxyalkyl group, or a C₆-C₂₀ heteroarylalkyl group.

As used herein, the term “halogen atom” refers to fluoro, bromo, chloro, or iodo.

As used herein, the term “a C₁-C₂₀ alkyl group substituted with a halogen atom” refers to a C₁-C₂₀ alkyl group that is substituted with one or more halo groups, and unlimited examples of a C₁-C₂₀ alkyl group that is substituted with one or more halo groups are monohaloalkyl, dihaloalkyl, and polyhaloalkyl including perhaloalkyl.

A monohaloalkyl has one iodo, bromo, chloro or fluoro within the alkyl group, and dihaloalkyl and polyhaloalkyl groups have two or more of the same halo atoms or a combination of different halo groups within the alkyl.

As used herein, the term “alkoxy” refers to alkyl-O—, wherein alkyl is defined herein above. Examples of alkoxy include, but are not limited to, methoxy, ethoxy, propoxy, 2-propoxy, butoxy, tert-butoxy, pentyloxy, hexyloxy, cyclopropyloxy-, cyclohexyloxy- and the like. At least one hydrogen atom of the alkoxy group may be substituted with the same substituent as described above in connection with the alkyl group.

The term alkoxyalkyl refers to an alkyl group, as defined above, in which the alkyl group is substituted with alkoxy. At least one hydrogen atom of the alkoxyalkyl group may be substituted with the same substituent as described above in connection with the alkyl group. The term alkoxyalkyl includes a substituted alkoxyalkyl moiety.

The term “alkenyl” refers to a branched or unbranched hydrocarbon having at least one carbon-carbon double bond. Examples of alkenyl are, but are not limited to, vinyl, allyl, butenyl, isopropenyl or isobutenyl. At least one hydrogen atom of the alkenyl group may be substituted with the same substituent as described above in connection with the alkyl group.

The term “alkynyl” refers to a branched or unbranched hydrocarbon having at least one carbon-carbon triple bond. Examples of alkynyl are, but are not limited to, ethynyl, butynyl, isobutynyl or isopropynyl.

At least one hydrogen atom of alkynyl may be substituted with the same substituent as described above in connection with the alkyl group.

The term “aryl” is used alone or in combination, and refers to an aromatic hydrocarbon group having one or more rings.

The term “aryl” also refers to a group in which an aromatic ring is fused to one or more cycloalkyl rings.

Examples of aryl are, but are not limited to, phenyl, naphthyl, or tetrahydronaphthyl.

At least one hydrogen atom of aryl may be substituted with the same substituent as described above in connection with the alkyl group.

The term “arylalkyl” is an alkyl substituted with aryl. Examples of arylalkyl are benzyl or Phenyl-CH₂CH₂—.

The term “aryloxy” includes an —O-aryl, wherein aryl is defined herein. Examples of aryloxy are phenoxy and the like. At least one hydrogen atom of aryloxy may be substituted with the same substituent as described above in connection with the alkyl group.

The term “heteroaryl” refers to a monocyclic or bicyclic organic compound that contains one or more hetero atoms selected from N, O, P, and S, and the remaining ring atoms are carbon atoms. The heteroaryl may include, for example, 1 to 5 hetero atoms, and 5 to 10 ring members.

S or N may be oxidized to various oxidation states.

Typical monocyclic heteroaryl groups include thienyl, furyl, pyrrolyl, imidazolyl, pyrazolyl, thiazolyl, isothiazolyl, 1,2,3-oxadiazolyl, 1,2,4-oxadiazolyl, 1,2,5-oxadiazolyl, 1,3,4-oxadiazolyl, 1,2,3-thiadiazolyl, 1,2,4-thiadiazolyl, 1,2,5-thiadiazolyl, 1,3,4-thiadiazolyl, isothiazol-3-yl, isothiazol-4-yl, isothiazol-5-yl, oxazol-2-yl, oxazol-4-yl, oxazol-5-yl, isooxazol-3-yl, isooxazol-4-yl, isooxazol-5-yl, 1,2,4-triazol-3-yl, 1,2,4-triazol-5-yl, 1,2,3-triazol-4-yl, 1,2,3-triazol-5-yl, tetrazolyl, pyrid-2-yl, pyrid-3-yl, 2-pyrazin-2yl, pyrazin-4-yl, pyrazin-5-yl, 2-pyrimidin-2-yl, 4-pyrimidin-2-yl, and 5-pyrimidin-2-yl.

The term “heteroaryl” also refer to a group in which a heteroaromatic ring is fused to one or more aryl, cycloaliphatic, or heterocyclic rings

Examples of bicyclic heteroaryl are indolyl, isoindolyl, indazolyl, indolizinyl, purinyl, quinolizinyl, quinolinyl, isoquinolinyl, cinnolinyl, phthalazinyl, naphthyridinyl, quinazolinyl, quinaxalinyl, phenanthridinyl, phenathrolinyl, phenazinyl, phenothiazinyl, phenoxazinyl, benzisoqinolinyl, thieno[2,3-b]furanyl, furo[3,2-b]-pyranyl, 5H-pyrido[2,3-d]-o-oxazinyl, 1H-pyrazolo[4,3-d]-oxazolyl, 4H-imidazo[4,5-d]thiazolyl, pyrazino[2,3-d]pyridazinyl, imidazo[2,1-b]thiazolyl, imidazo[1,2-b][1,2,4]triazinyl, 7-benzo[b]thienyl, benzoxazolyl, benzimidazolyl, benzothiazolyl, benzoxapinyl, benzoxazinyl, 1H-pyrrolo[1,2-b][2]benzazapinyl, benzofuryl, benzothiophenyl, benzotriazolyl, pyrrolo[2,3-b]pyridinyl, pyrrolo[3,2-c]pyridinyl, pyrrolo[3,2-b]pyridinyl, imidazo[4,5-b]pyridinyl, imidazo[4,5-c]pyridinyl, pyrazolo[4,3-d]pyridinyl, pyrazolo[4,3-c]pyridinyl, pyrazolo[3,4-c]pyridinyl, pyrazolo[3,4-d]pyridinyl, pyrazolo[3,4-b]pyridinyl, imidazo[1,2-a]pyridinyl, pyrazolo[1,5-a]pyridinyl, pyrrolo[1,2-b]pyridazinyl, imidazo[1,2-c]pyrimidinyl, pyrido[3,2-d]pyrimidinyl, pyrido[4,3-d]pyrimidinyl, pyrido[3,4-d]pyrimidinyl, pyrido[2,3-d]pyrimidinyl, pyrido[2,3-b]pyrazinyl, pyrido[3,4-b]pyrazinyl, pyrimido[5,4-d]pyrimidinyl, pyrazino[2,3-b]pyrazinyl, and pyrimido[4,5-d]pyrimidinyl.

At least one hydrogen atom in the heteroaryl group may be substituted with the same substituent as described above in connection with the alkyl group.

The term “heteroarylakyl” refers to alkyl substituted with heteroaryl.

The term “heteroaryloxy” includes an —O-heteroaryl moiety. At least one hydrogen atom in heteroaryloxy may be substituted with the same substituent as described above in connection with the alkyl group.

The term “heteraryloxyalkyl” refers to an alkyl group that is substituted with heteroaryloxy. At least one hydrogen atom in heteraryloxyalkyl may be substituted with the same substituent as described above in connection with the alkyl group.

As used herein, the term “carbocyclic” refers to saturated or partially unsaturated but non-aromatic monocyclic, bicyclic or tricyclic hydrocarbon groups.

Exemplary monocyclic hydrocarbon groups include cyclopentyl, cyclopentenyl, cyclohexyl and cyclohexenyl.

Exemplary bicyclic hydrocarbon groups include bornyl, decahydronaphthyl, bicyclo[2.1.1]hexyl, bicyclo[2.2.1]heptyl, bicyclo[2.2.1]heptenyl, and bicyclo[2.2.2]octyl.

Exemplary tricyclic hydrocarbon groups include adamantyl.

At least one hydrogen atom in carbocyclic may be substituted with the same substituent as described above in connection with the alkyl group.

The term “heterocyclic” refers to a ring containing 5-10 ring atoms including a hetero atom such as N, S, P, or O, and an example of heterocyclic is pyridyl. At least one hydrogen atom in heterocyclic may be substituted with the same substituent as described above in connection with the alkyl group.

The term “heterocyclicoxy” includes an —O-heterocyclic, and at least one hydrogen atom in heterocyclicoxy may be substituted with the same substituent as described above in connection with the alkyl group.

The term “sulfonyl” includes R″—SO₂—, wherein R″ is hydrogen, alkyl, aryl, heteroaryl, aryl-alkyl, heteroaryl-alkyl, alkoxy, aryloxy, cycloalkyl, or heterocyclic.

The term “sulfamoyl” includes H₂NS(O)₂—, alkyl-NHS(O)₂—, (alkyl)₂NS(O)₂—, aryl-NHS(O)₂—, alkyl(aryl)-NS(O)₂—, (aryl)₂NS(O)₂—, heteroaryl-NHS(O)₂—, (aryl-alkyl)-NHS(O)₂—, or (heteroaryl-alkyl)-NHS(O)₂—.

At least one hydrogen atom in sulfamoyl may be substituted with the same substituent as described above in connection with the alkyl group.

The term “amino” includes compounds wherein a nitrogen atom is covalently bonded to at least one carbon or heteroatom. The term “amino” also includes —NH₂ and also includes substituted moieties.

The term also includes “alkyl amino” wherein the nitrogen is bound to at least one additional alkyl group. The term also includes “arylamino” and “diarylamino” groups wherein the nitrogen is bound to at least one or two independently selected aryl groups, respectively.

The term “alkylene”, “alkenylene”, “alkynylene”, “arylene”, and “heteroarylene” are defined as described above, except that “alkyl”, “alkenyl”, “alkynyl”, “aryl”, and “heteroaryl”, which are mono-valent groups, are changed into divalent groups.

At least one hydrogen atom in “alkylene”, “alkenylene”, “alkynylene”, “arylene”, and “heteroarylene” may be substituted with the same substituent as described above in connection with the alkyl group.

Hereinafter, one or more embodiments of the present invention will be described in detail with reference to the following examples. These examples are not intended to limit the purpose and scope of the one or more embodiments of the present invention.

### Synthesis Example 1

### Preparation of Compound Represented by Formula 2

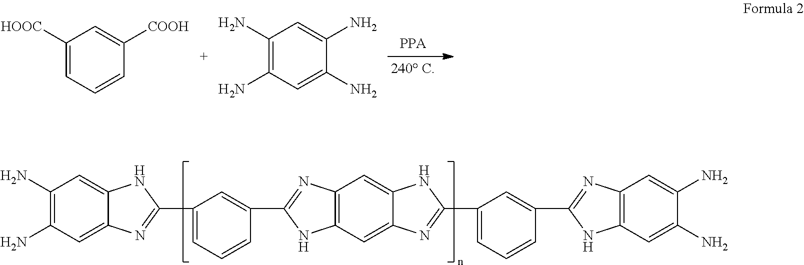

In Formula 2, n was 30.

4.61 g of 1,2,4,5-tetraminobenzene (0.033 mol) was put into 218 g of polyphosphoric acid solvent at a temperature of 150° C., and was dissolved for 3 hours. Then, 5.39 g of isophthalic acid (0.032 mol) was put into the resulting solution, and a polymerization reaction proceeded for 12 hours at a temperature of 240°.

A polymerization solution obtained through the polymerization reaction was put into distilled water to obtain precipitates. A solvent was completely removed from the precipitates to dry precipitates in a powder state.

The structure of the compound of Formula 2 prepared in Synthesis Example 1 was identified using nuclear magnetic resonance (NMR) spectroscopy.

### Synthesis 2

### Preparation of Compound Represented by Formula 3

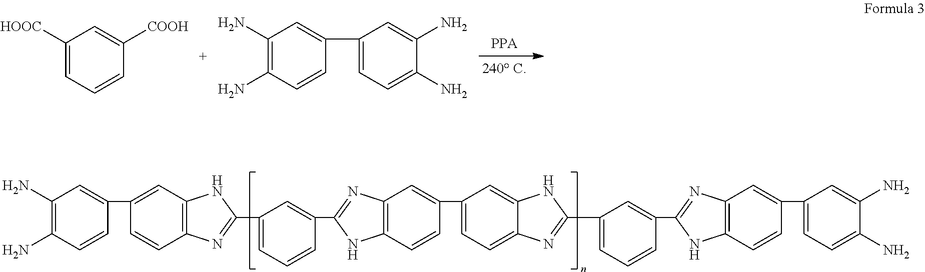

In Formula 3, n was 30.

13.2 g of 3,3′,4,4′-tetraminobiphenyl (0.033 mol) was put into 218 g of polyphosphoric acid at a temperature of 150° C., and was dissolved for 3 hours. Then, 5.39 g of isophthalic acid (0.032 mol) was put into the resulting solution, and a polymerization reaction proceeded for 12 hours at a temperature of 240° C.

The polymerization solution obtained through the polymerization reaction was put into distilled water to obtain precipitates. The solvent was completely removed from the precipitates to dry precipitates in a powder state.

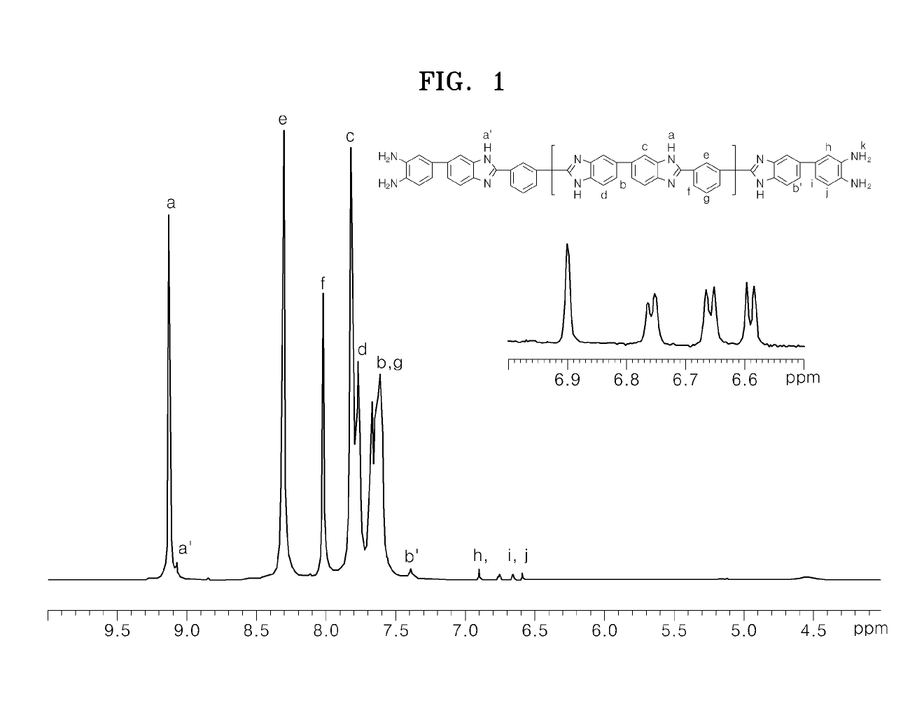

The structure of the compound of Formula 3 prepared in Synthesis Example 2 was identified using nuclear magnetic resonance (NMR) spectroscopy of FIG. 1.

### Example 1-1

### Preparation of Cross-Linked Material Represented by Formula 3A and Preparation of Electrolyte Membrane Including the Cross-Linked Material

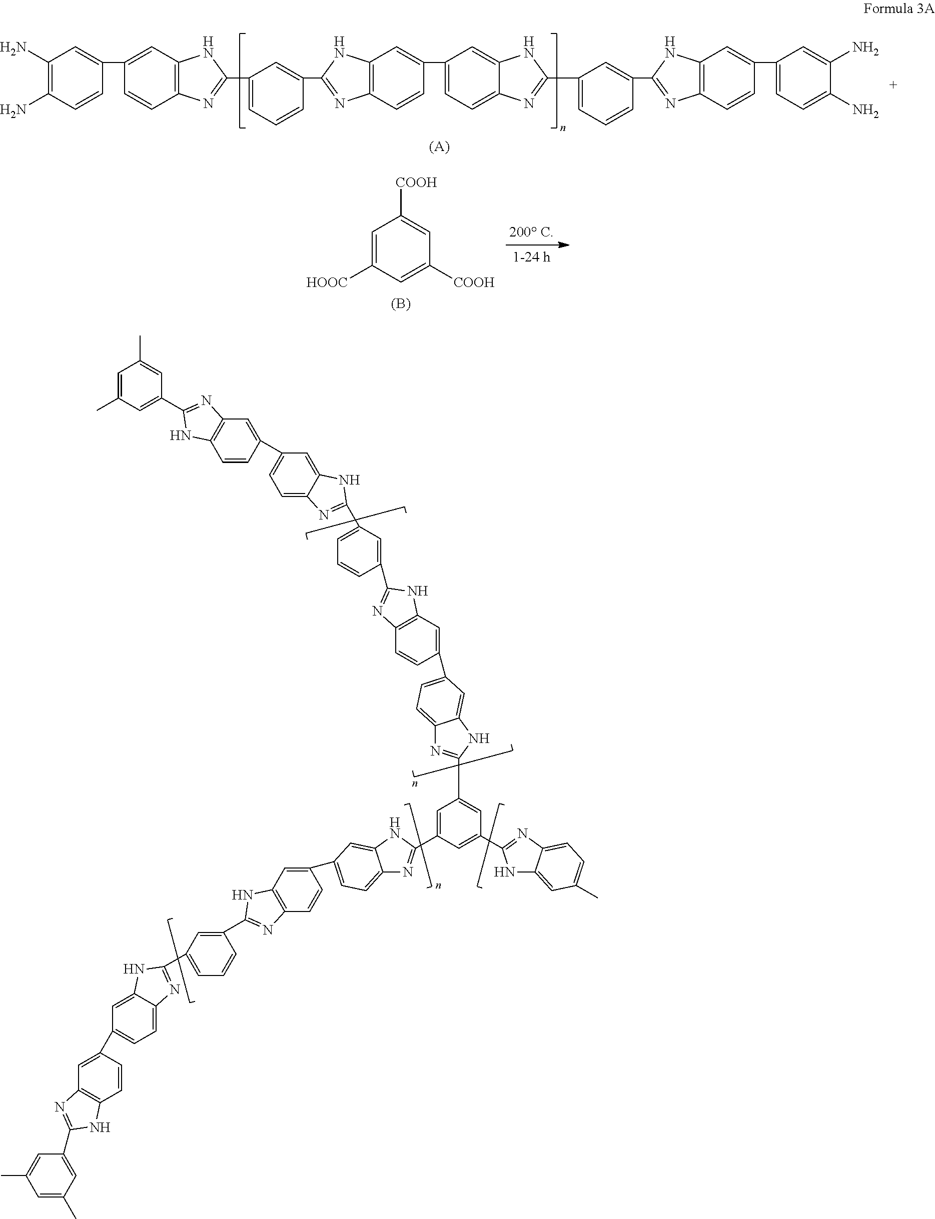

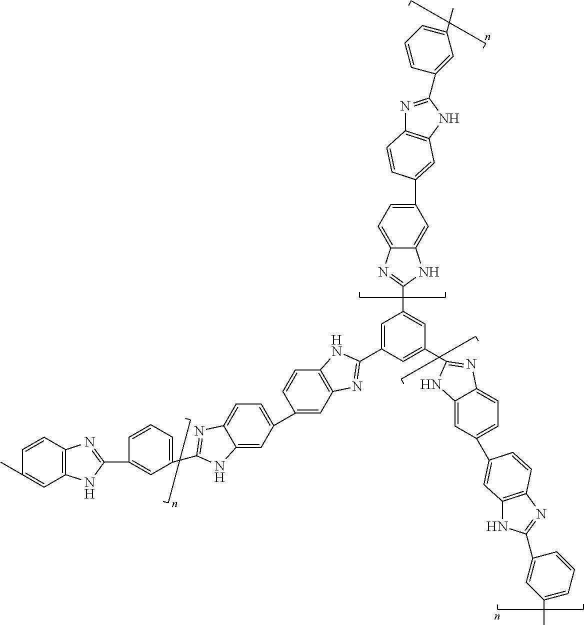

In Formula 3A, n was 30.

1 equivalent weight of a compound (A) represented by Formula 3 and 0.33 equivalent weight of 1,3,5-benzenetricarboxylic acid (B), which were included in Formula 3A, were dissolved in 10 g of dimethylacetamide, the resulting solution was casted on a glass plate, a solvent was removed from the resulting solution at a temperature of 60° C., and then the solvent was dried at a temperature of 200° C. to prepare a cross-linked material of the compound represented by Formula 3A.

Subsequently, the cross-linked material of the compound represented by Formula 3A was impregnated with 85 wt % of phosphoric acid at 80° C. for 4 hours or longer to form an electrolyte membrane. Herein, the amount of phosphoric acid was about 530 parts by weight, based on 100 parts by weight of the electrolyte membrane.

The structure of the cross-linked material prepared in Example 1 was identified using nuclear magnetic resonance (NMR) spectroscopy and IR spectroscopy.

### Example 1-2

### Preparation of Cross-Linked Material Represented by Formula 3A and Preparation of Electrolyte Membrane for Fuel Cell, Including the Cross-Linked Material

A cross-linked material represented by Formula 3A and an electrolyte membrane including the cross-linked material were prepared in the same manner as in Example 1-1, except that 0.67 equivalent weight of 1,3,5-benzenetricarboxylic acid (B) was used, instead of 0.33 equivalent weight of 1,3,5-benzenetricarboxylic acid (B).

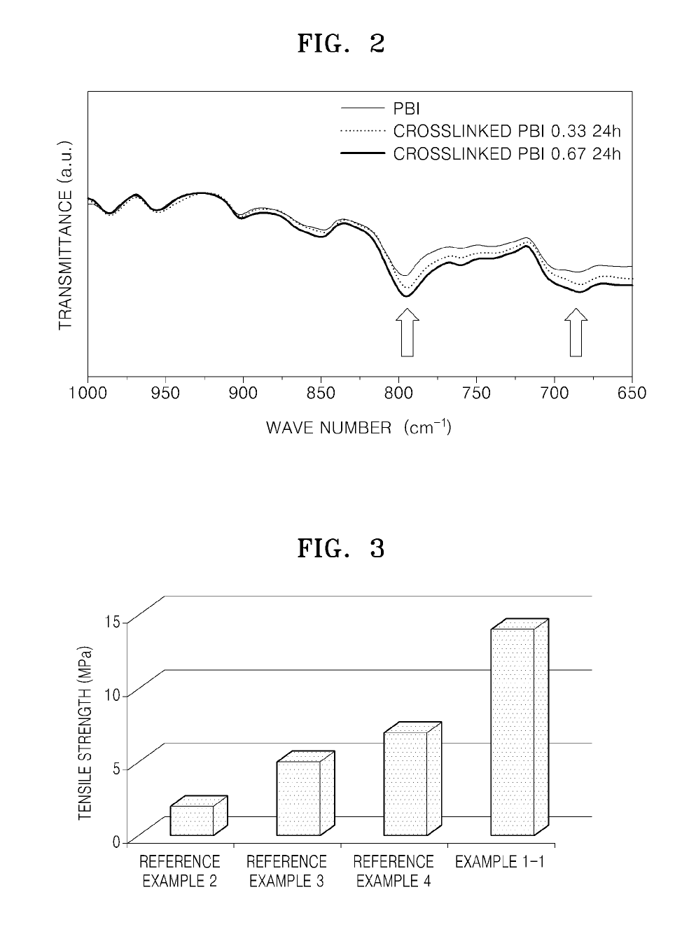

FIG. 2 shows infrared (IR) spectrum of the cross-linked material and polybenzimidazole prepared in Examples 1-1 and 1-2. In FIG. 2, PBI denotes polybenzimidazole, “Crosslinked FBI 0.33 24h” denotes the cross-linked terminated polybenzimidazole prepared by using 0.33 mol equivalent weight of 1,3,5-benzenetricarboxylic acid based on a compound (A) represented by Formula 3, according to Example 1: 1, and “Crosslinked PBI 0.67 24h” denotes the cross-linked material prepared by using 0.67 mol equivalent weight of 1,3,5-benzenetricarboxylic acid based on the compound (A) represented by Formula 3, according to an Example 1-2.

### Example 2

### Preparation of Double Cross-Linked Polymer Derived from Cross-Linked Material and Preparation of Electrolyte Membrane for Fuel Cell, Including the Double Cross-Linked Polymer

65 weight by parts of a compound (PPO) represented by Formula 162 below was blended in 35 weight by parts of the cross-linked material of the compound represented by Formula 3A prepared in Example 1-1, and a curing reaction proceeded on the resultant at a temperature of about 250° C., thereby preparing a double cross-linked polymer.

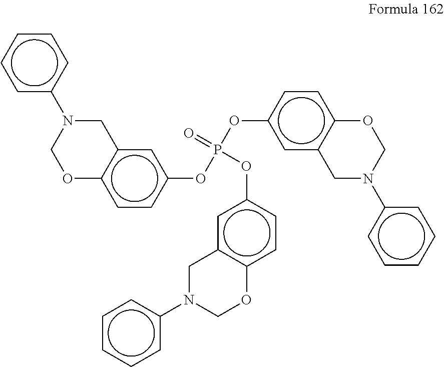

Subsequently, the resultant was impregnated with 85 wt % of phosphoric acid at a temperature of 80° C. for 4 hours or longer to form an electrolyte membrane. Herein, the amount of phosphoric acid was about 530 parts by weight, based on 100 parts by weight of the electrolyte membrane.

### Example 3

### Preparation of Electrode

An electrode was prepared using the cross-linked material of the compound represented by Formula 3A prepared in Example 1-1 as follows.

An electrode was prepared using the cross-linked material prepared according to Example 1 as follows.

1 g of a catalyst including 50 wt % of Pt/Co loaded on carbon, and 3 g of N-methylpyrrolidone (NMP) as a solvent were added to a stirring vessel, and the mixture was stirred to prepare a slurry.

0.025 g of the cross-linked material represented by Formula 3A prepared in Example 1-1 was added to the slurry. The mixture was mixed for 10 minutes to prepare a slurry for forming a cathode catalyst layer.

Carbon paper was cut to a size of 4×7 cm², fixed on a glass plate, and coated with the slurry by using a doctor blade (Sheen Instruments Ltd) having a gap of about 600 μm.

The slurry for the cathode catalyst layer was coated on the carbon paper, and dried at room temperature for one hour, at 80° C. for one hour, at 120° C. for 30 minutes, and at 150° C. for 15 minutes to form cathodes (fuel electrodes). The amount of loaded Pt/Co in the prepared cathode was 3.0 mg/cm².

### Reference Example 1

### Preparation of Electrolyte Membrane Including Polybenzimidazole (PBI)

12.8 g of 3,3′,4,4′-tetraminobiphenyl (0.032 mol) was put into 218 g of polyphosphoric acid at a temperature of 150° C., and was dissolved for 3 hours. Then, 5.39 g of isophthalic acid (0.032 mol) was put into the resulting solution, and a polymerization reaction proceeded for 12 hours at a temperature of 240° C.

The polymerization solution obtained through the polymerization reaction was put into distilled water to obtain precipitates. The solvent was completely removed from the precipitates to dry precipitates in a powder state.

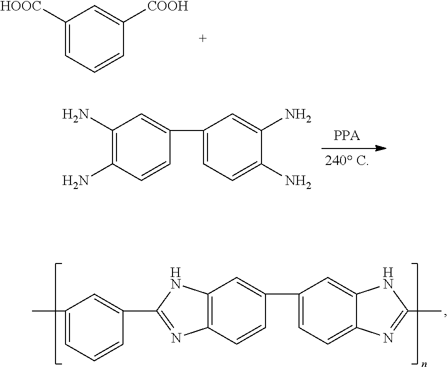

where n is about 30.

Subsequently, the polybenzimidazole was impregnated with 85 wt % of phosphoric acid at 80° C. for 4 hours or longer to form an electrolyte membrane. Herein, the amount of phosphoric acid was about 530 parts by weight, based on 100 parts by weight of the electrolyte membrane. The tensile strength of the electrode membrane prepared in Example 1-1 was measured. The result is shown in FIG. 3. In this case, the tensile strength was estimated by UTM (Model Number: universal testing machine (Lloyd LR-10K)), and specimens were collectively manufactured and estimated by ASTM standard D638 (Type V specimens).

FIG. 3 is a graph of a tensile strength of an electrolyte membrane prepared in Example 1-1 together with a tensile strength of electrolyte membranes of Reference Examples 2 through 4, for comparison between Example 1-1 and Reference Examples 2 through 4.

Reference Example 2 is related to a p-PBI electrolyte membrane represented by Formula 164 below. Reference Example 3 is related to an electrolyte membrane formed by blending 60 parts by weight of a compound represented by Formula 56 below, 3 parts by weight of a compound represented by Formula 110 below and 37 parts by weight of a compound (m-PBI) represented by Formula 165 below and then proceeding with a curing reaction on the resultant at a temperature of about 250° C. Reference Example 4 is related to an electrolyte membrane formed by blending 65 parts by weight of a compound represented by Formula 162 below and 35 parts by weight of a compound (m-PBI) represented by Formula 165 below and then proceeding with a curing reaction on the resultant at a temperature of about 250° C.

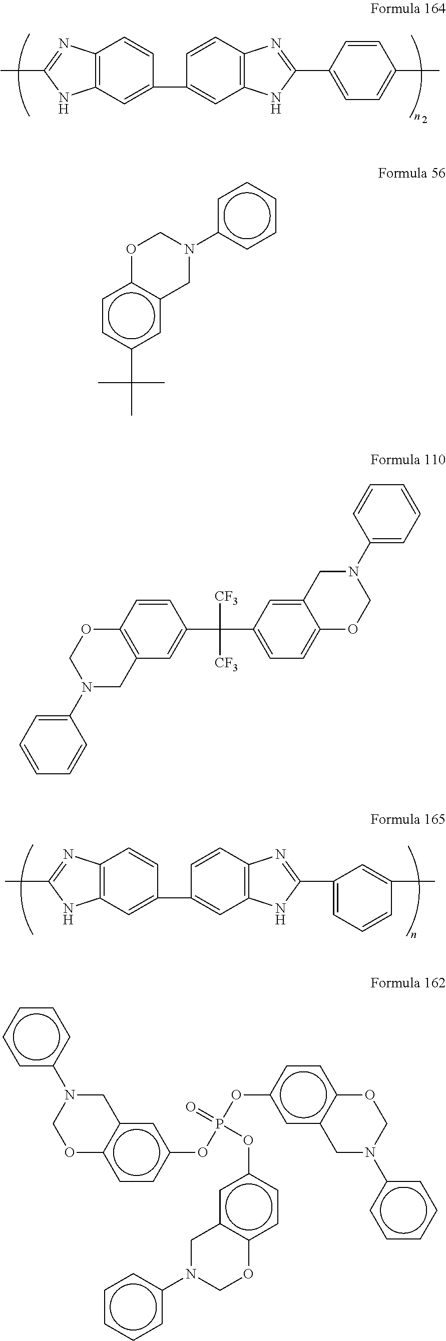

As shown in FIG. 3, the tensile strength of the electrolyte membrane prepared in Example 1-1 is excellent compared to the electrolyte membranes of Reference Examples 2 through 4.

### Manufacture Example 1

### Manufacture of Fuel Cell

1 g of a catalyst including 50 wt % of Pt/Co loaded on carbon, and 3 g of N-methylpyrrolidone (NMP) as a solvent were added to a stirring vessel, and the mixture was stirred to prepare a slurry. Subsequently, a solution of 5 wt % of polyvinylidene fluoride in NMP was added to the slurry until the amount of polyvinylidene fluoride in the mixture reached 0.025 g. The mixture was mixed for 10 minutes to prepare a slurry for forming a cathode catalyst layer.

Carbon paper was cut to a size of 4×7 cm², fixed on a glass plate, and coated with the slurry by using a doctor blade (Sheen Instruments Ltd) having a gap of about 600 μm.

The slurry for the cathode catalyst layer was coated on the carbon paper, and dried at room temperature for one hour, at 80° C. for one hour, at 120° C. for 30 minutes, and at 150° C. for 15 minutes to form cathodes (fuel electrodes). The amount of loaded Pt/Co in the prepared cathode was 3.0 mg/cm².

Anodes were manufactured as follows.

2 g of a Pt catalyst on which 50 wt % of Pt is supported on carbon and 9 g of N-methylpyrrolidone (NMP) as a solvent were put into a stirring vessel, and stirred using a high-speed stirrer for two minutes.

Subsequently, a solution of 0.05 g of polyvinylidene fluoride dissolved in 1 g of NMP was added to the mixture, and the resultant was further stirred for 2 minutes to prepare a slurry for forming an anode catalyst layer. The slurry was coated on carbon paper, which was coated with a microporous layer, using a bar coater, to complete the manufacture of the anode. The loading amount of Pt in the anode was 1.4 mg/cm².

The amount of loaded Pt/Co in the cathode was about 2.33 mg/cm², and the amount of loaded Pt in the anode was 1.4 mg/cm².

The electrolyte membrane of Example 1-1 was disposed between the cathode and the anode to manufacture an MEA. The cathode and the anode were not impregnated with phosphoric acid.

To prevent gas permeation between the cathode and the anode, a PTFE membrane main-gasket having a thickness of 200 μm and a PTFE membrane sub-gasket having a thickness of 20 μm were joined and disposed between each of the anode and cathode, and the electrolyte membrane. The pressure applied to the MEAs was adjusted using a torque wrench, and was stepwise increased using 1, 2, and 3 N-m Torque wrenches.

Electricity was generated by supplying hydrogen to the anode (flow rate: 100 ccm) and air to the cathode (flow rate: 250 ccm), at 150° C., without humidifying the electrolyte membrane, and characteristics of the fuel cell were measured. Here, since an electrolyte doped with phosphoric acid was used, the performance of the fuel cell improved as time went by. Thus, the fuel cell was aged until its operating voltage reached its highest point and then a final evaluation was conducted. In addition, the surface areas of the cathode and the anode were fixed to 2.8×2.8 (7.84 cm²). The thickness of the cathode was about 430 μm, and the thickness of the anode was about 390 μm.

### Manufacture Example 2

### Manufacture of Fuel Cell Including Electrolyte Membrane of Example 2

A fuel cell was manufactured in the same manner as in Manufacture Example 1, except that the electrolyte membrane prepared in Example 2 was used, instead of the electrolyte membrane prepared in Example 1-1.

### Manufacture Example 3

### Manufacture of Fuel Cell Including Electrode of Example 3

A fuel cell was manufactured in the same manner as in Manufacture Example 1, except that the electrode of Example 3 was used as a cathode.

Reference Manufacture Example 1

### Manufacture of Fuel Cell Including Electrolyte Membrane of Example 1

A fuel cell was manufactured in the same manner as in Manufacture Example 1, except that the PBI electrolyte membrane prepared in Reference Example 1 was used, instead of the electrolyte membrane of Example 1-1.

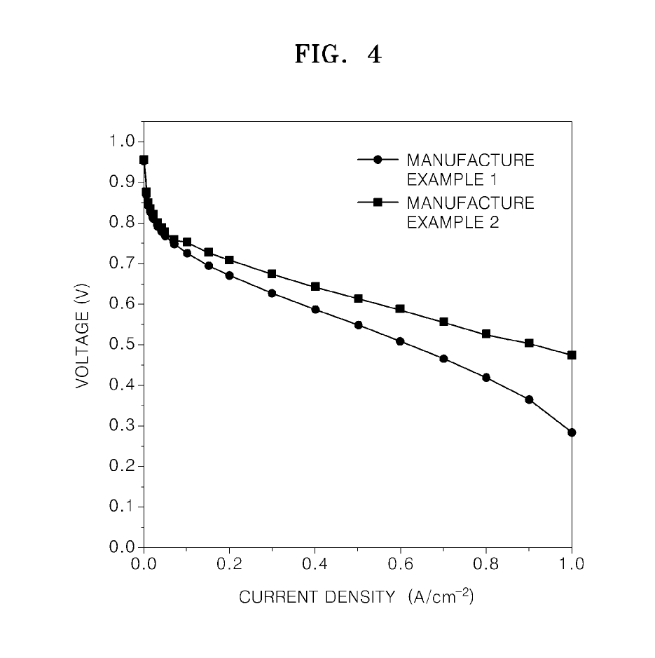

Changes in voltages of the fuel cells manufactured in Manufacture Examples 0.1 and 2 with respect to current density were measured. The results are shown in FIG. 4.

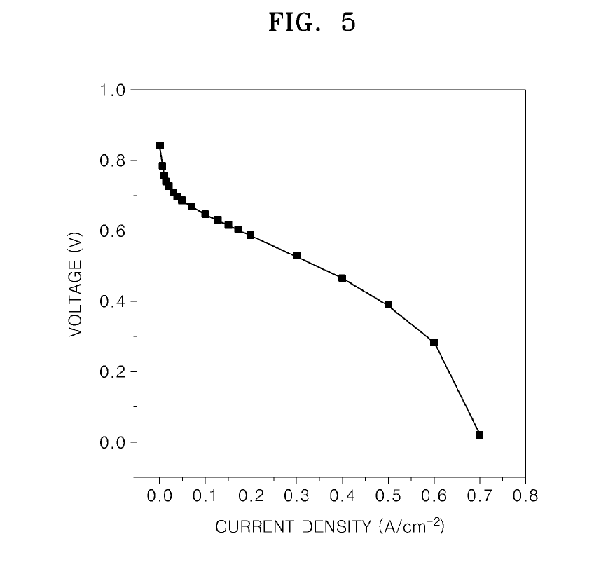

Referring to FIG. 4, the fuel cells manufactured in Manufacture Examples 1 and 2 exhibited excellent cell voltage characteristics, and in particular, the stable performance in a high current-density region. Voltage characteristics with respect to current density of the fuel cell prepared in Manufacture Example 3 were estimated. The results are shown in FIG. 5.

As shown in FIG. 5, the voltage characteristics of the fuel cell of Manufacture Example 3 are excellent.

As described above, according to the one or more of the above embodiments of the present invention, a compound, a cross-linked material of the compound and a double cross-linked polymer thereof have the improved amount of phosphoric acid and mechanical properties. The compound, the cross-linked material of the compound and the double cross-linked polymer thereof are used in an electrode for a fuel cell, and an electrolyte membrane for a fuel cell, the performance of the fuel cell may be improved.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A compound represented by Formula 1 below: 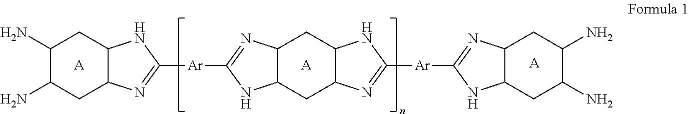
wherein, in Formula 1, 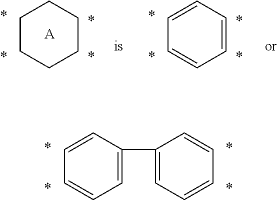
Ar is a substituted or unsubstituted C₆-C₂₀ arylene group or a substituted or unsubstituted C₃-C₂₀ hetero arylene group, and
n is a number from 1 to 300.

2. The compound of claim 1, wherein, in Formula 1, Ar is selected from the group represented from Formula 1A below:

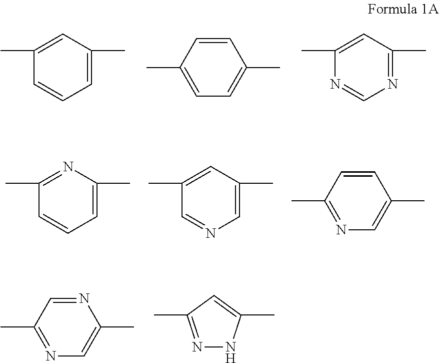

3. The compound of claim 1, wherein the compound is represented by Formula 2 or 3 below: 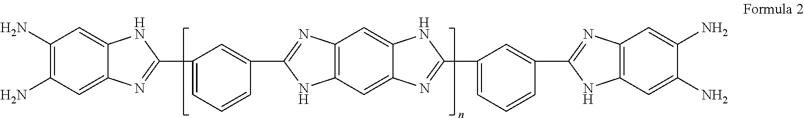
wherein, in Formula 2, n is a number form 1 to 300. 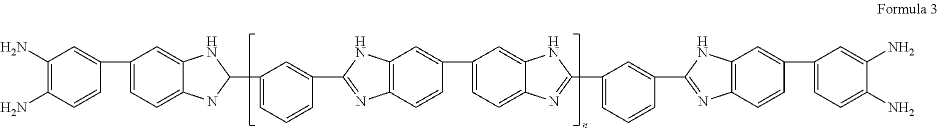
wherein, in Formula 3, n is a number from 1 to 300.

4. A cross-linked material obtained through a cross-linking reaction of a compound represented by Formula 1 below: 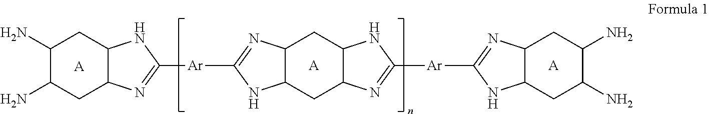
, wherein, in Formula 1, 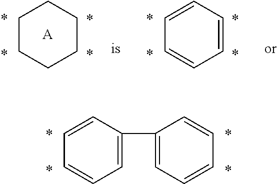
Ar is a substituted or unsubstituted C₆-C₂₀ arylene group or a substituted or unsubstituted C₃-C₂₀ heteroarylene group, and
n is a number from 1 to 300,

5. The cross-linked material of claim 4, wherein the cross-linking reaction is a cross-linking reaction between the compound represented by Formula 1, or a cross-linking reaction between the compound represented by Formula 1 and at least one carboxylic acid compound selected from the group consisting of aromatic tricarboxylic acid, heteroaromatic tricarboxylic acid, aromatic tetracarboxylic acid, and heteroaromatic tetracarboxylic acid.

6. The cross-linked material of claim 5, wherein the carboxylic acid compound is represented by Formula 4 or 5 below:

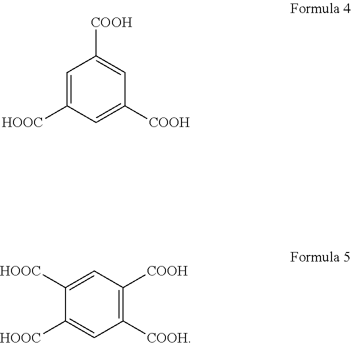

7. The cross-linked material of claim 5, wherein the amount of the carboxylic acid compound is about 0.1 to about 2 mol based on 1 mol of the compound represented by Formula 1.

8. The cross-linked material of claim 4, wherein the cross-linked material comprises a unit represented by Formula 6 or 7 below: 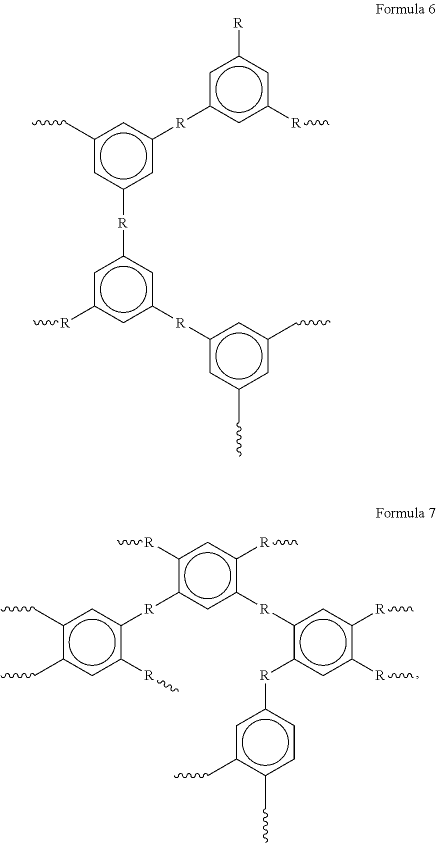
wherein, in Formulae 6 and 7, R is selected from among the groups represented by Formulae 14 through 40 below: 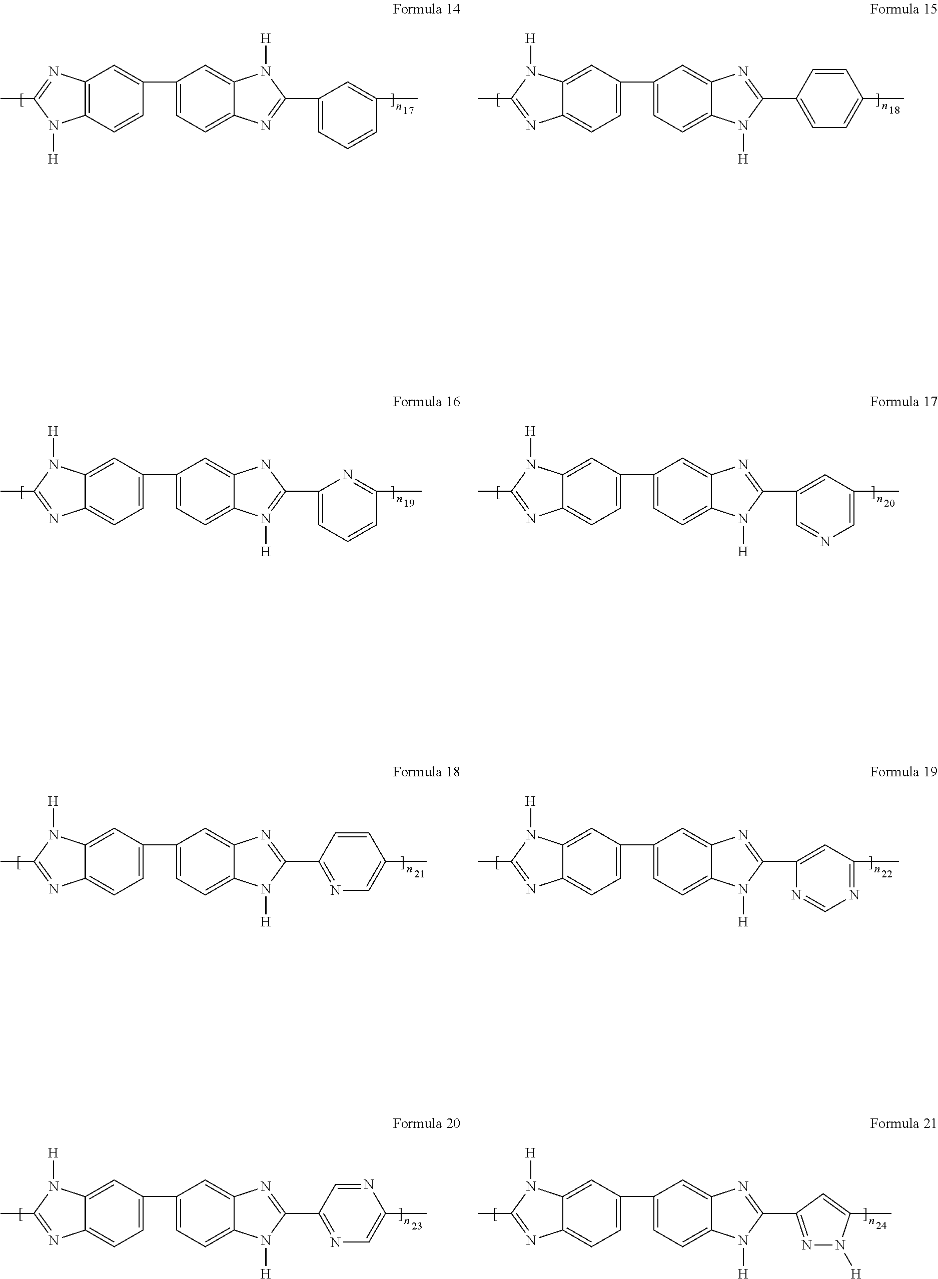 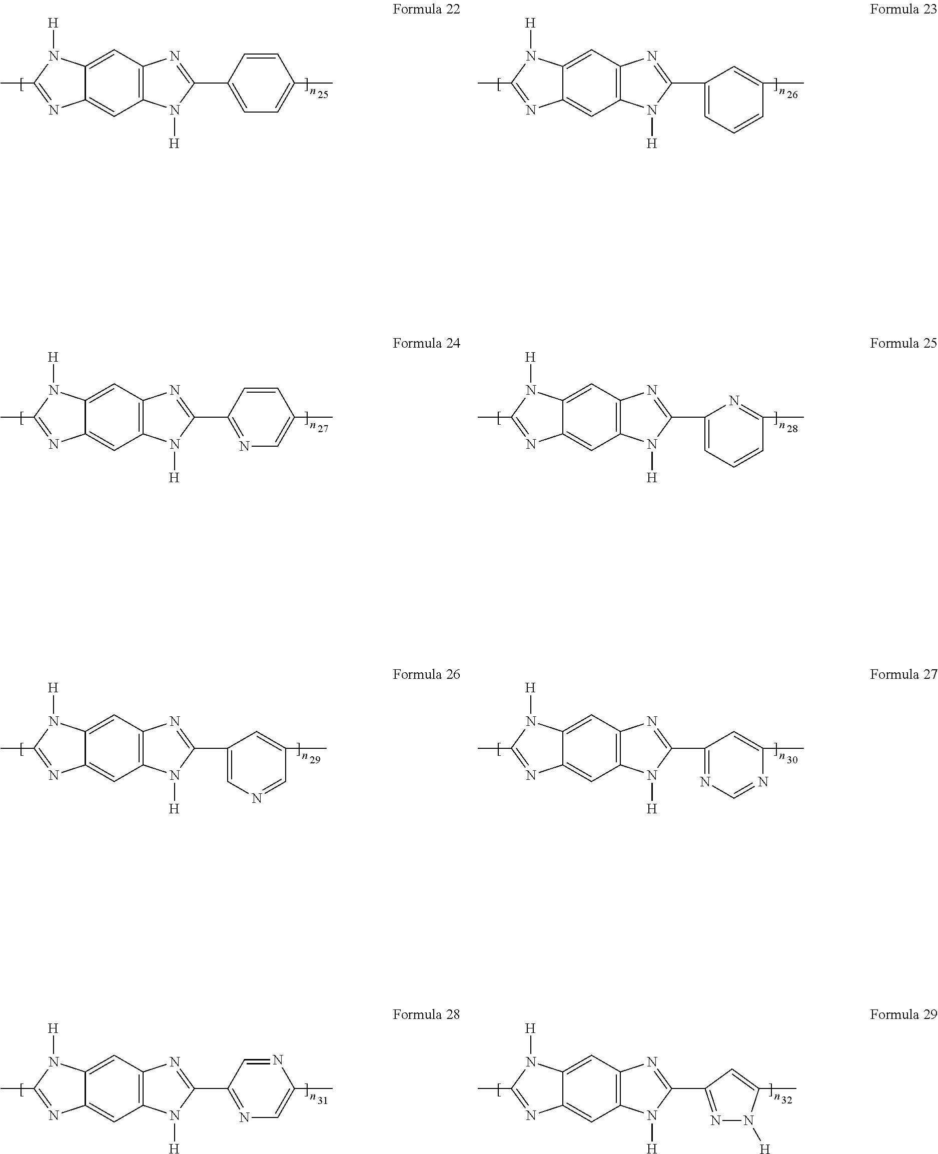 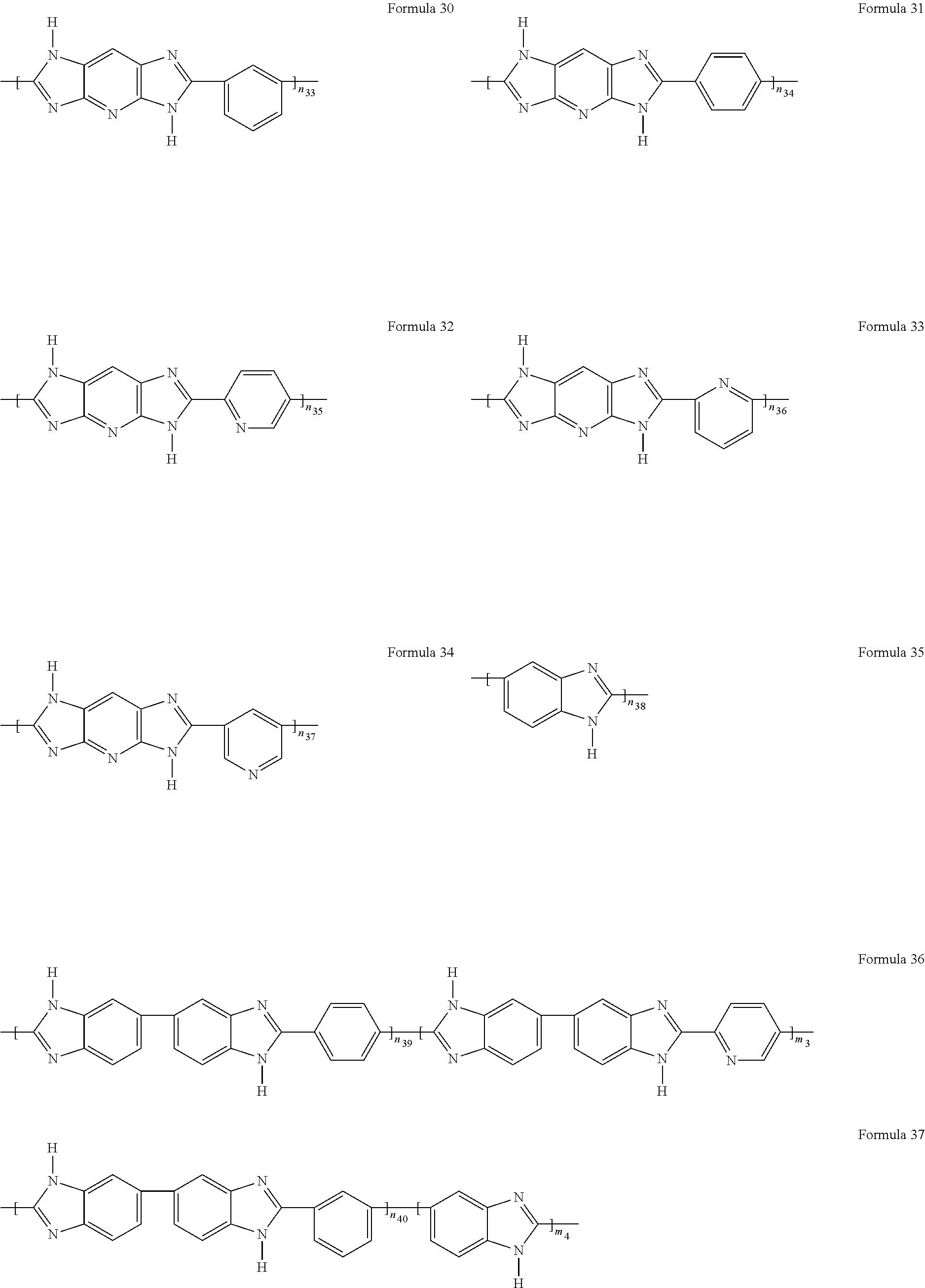 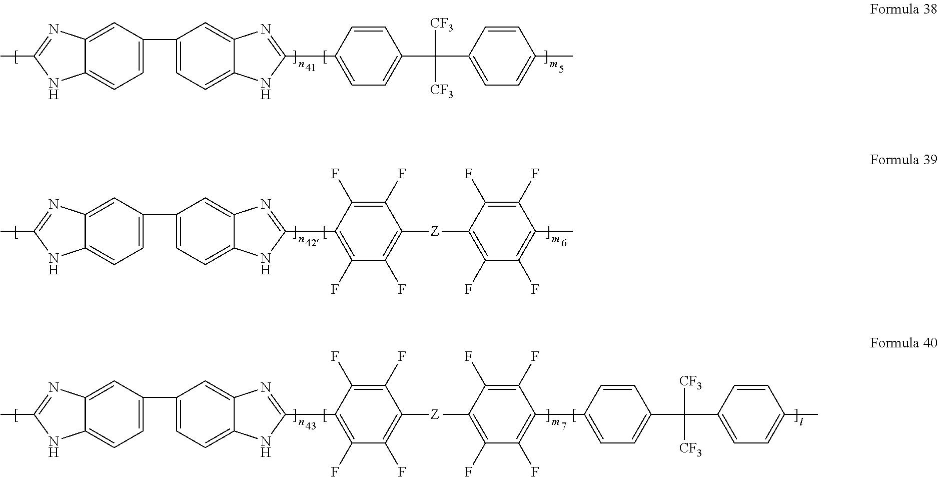
where in Formulae 14 through 40 above, l, n₁₇ through n₄₃, and m₃ through m₇ are each independently an integer of 10 or greater, z indicates chemical bonding, or —(CH₂)ₛ—, —C(═O)—, —SO₂—, —C(CH₃)₂— or —C(CF₃)₂—, and s is an integer of 1 to 5.

9. A double cross-linked polymer obtained through a cross-linking reaction of a composition comprising the cross-linked material of claim 4 and an oxazine-based monomer.

10. The double cross-linked polymer of claim 9, wherein the oxazine-based monomer comprises at least one material selected from the compounds represented by Formulae 8 through 13 below: 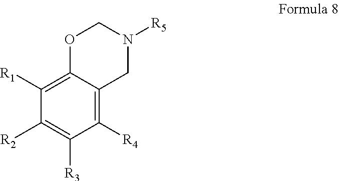
wherein, in Formula 8, R₁ through R₄ are each independently a hydrogen atom, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₂-C₂₀ heteroaryl group, a substituted or unsubstituted C₂-C₂₀ heteroaryloxy group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, a halogen atom, a hydroxy group, or a cyano group,
R₅ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, 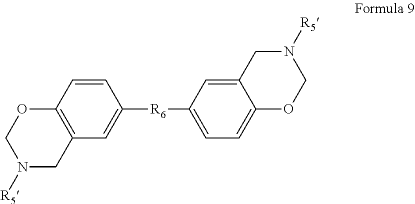
wherein, in Formula 9, R₅′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₈-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbocyclic group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, and
R₆ is selected from the group consisting of a substituted or unsubstituted C₁-C₂₀ alkylene group, a substituted or unsubstituted C₂-C₂₀ alkenylene group, a substituted or unsubstituted C₂-C₂₀ alkynylene group, a substituted or unsubstituted C₆-C₂₀ arylene group, a substituted or unsubstituted C₂-C₂₀ heteroarylene group, —C(═O)—, and —SO₂—, 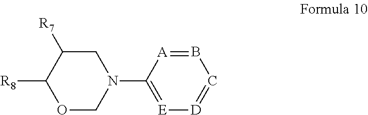
wherein, in Formula 10, A, B, C, D and E are all carbon; or one or two of A, B, C, D and E is nitrogen and the others are carbon,
R₇ and R₈ are linked to form a ring, and
the ring is a C₆-C₁₀ cycloalkyl group, a C₃-C₁₀ heteroaryl group, a fused C₃-C₁₀ heteroaryl group, a C₃-C₁₀ heterocyclic group or a fused C₃-C₁₀ heterocyclic group, 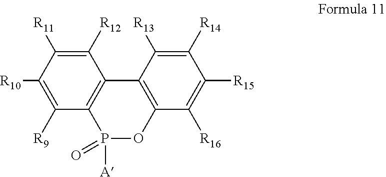
wherein, in Formula 11, A′ is a substituted or unsubstituted C₁-C₂₀ heterocyclic group, a substituted or unsubstituted C₄-C₂₀ cycloalkyl group, or a substituted or unsubstituted) C₁-C₂₀ alkyl group, and
R₉ through R₁₆ are each independently a hydrogen atom, a C₁-C₂₀ alkyl group, a C₁-C₂₀ alkoxy group, a C₆-C₂₀ aryl group, a C₆-C₂₀ aryloxy group, a C₁-C₂₀ heteroaryl group, a C₁-C₂₀ heteroaryloxy group, a C₄-C₂₀ cycloalkyl group, a C₁-C₂₀ heterocyclic group, a halogen atom, a cyano group, or a hydroxy group, 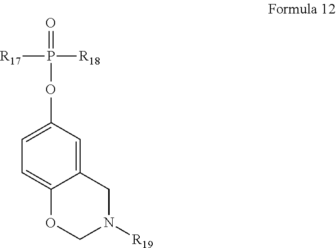
wherein, in Formula 12, R₁₇ and R₁₈ are each independently a C₁-C₂₀ alkyl group, a C₁-C₂₀ alkoxy group, a C₆-C₂₀ aryl group, a C₆-C₂₀ aryloxy group or a group represented by Formula 12A below: 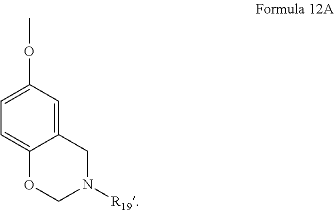
wherein, in Formulae 12 and 12A, R₁₉ and R_{19′} are each a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ cycloalkyl group, a halogenated C₄-C₂₀ cycloalkyl group, a C₁-C₂₀ heterocyclic group or a halogenated C₁-C₂₀ heterocyclic group, 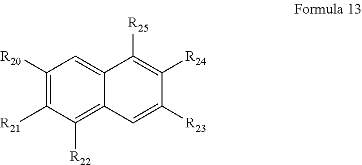
wherein, in Formula 13, at least two adjacent groups selected from among R₂₀, R₂₁ and R₂₂ are linked to form a group represented by Formula 13A below, and the non-selected, remaining group is a hydrogen atom, a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group, and
at least two adjacent groups selected from among R₂₃, R₂₄ and R₂₅ are linked to form the group represented by Formula 13A below, and the non-selected, remaining group is a C₁-C₂₀ alkyl group, a C₁-C₂₀ alkoxy group, a C₆-C₂₀ aryl group, a C₆-C₂₀ aryloxy group, a halogenated C₆-C₂₀ aryl group, a halogenated C₆-C₂₀ aryloxy group, a C₁-C₂₀ heteroaryl group, a C₁-C₂₀ heteroaryloxy group, a halogenated C₁-C₂₀ heteroaryl group, a halogenated C₁-C₂₀ heteroaryloxy group, a C₄-C₂₀ carbon ring group, a halogenated C₄-C₂₀ carbon ring group, a C₁-C₂₀ heterocyclic group or a halogenated C₁-C₂₀ heterocyclic group, 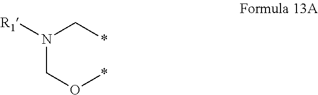
wherein, in Formula 13A, R₁′ is a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₆-C₂₀ aryl group, a substituted or unsubstituted C₆-C₂₀ aryloxy group, a substituted or unsubstituted C₇-C₂₀ arylalkyl group, a substituted or unsubstituted C₂-C₂₀ heteroaryl group, a substituted or unsubstituted C₂-C₂₀ heteroaryloxy group, a substituted or unsubstituted C₂-C₂₀ heteroarylalkyl group, a substituted or unsubstituted C₄-C₂₀ carbon ring group, a substituted or unsubstituted C₄-C₂₀ carbocyclic alkyl group, a substituted or unsubstituted C₂-C₂₀ heterocyclic group, or a substituted or unsubstituted C₂-C₂₀ heterocyclic alkyl group, and
* denotes the sites at which the at least two adjacent groups selected from among R₂₀, R₂₁ and R₂₂ of Formula 13 and the at least two adjacent groups selected from among R₂₃, R₂₄ and R₂₅ are linked, respectively.

11. The double cross-linked polymer of claim 9, wherein the amount of the oxazine-based monomer is in the range of about 1 parts to about 500 parts by weight, based on 100 parts by weight of the cross-linked material.

12. An electrolyte membrane for a fuel cell, the electrolyte membrane comprising the cross-linked material of claim 4.

13. An electrolyte membrane for a fuel cell, the electrolyte membrane comprising the double cross-linked polymer of claim 9.

14. An electrode for a fuel cell, the electrode comprising the cross-linked material of claim 4.

15. An electrode for a fuel cell, the electrode comprising the double cross-linked polymer of claim 9.

16. A fuel cell comprising a cathode; an anode; and an electrolyte membrane disposed between the cathode and the anode,
wherein at least one of the cathode, the anode and the electrolyte membrane comprises the cross-linked material of claim 4.

17. A fuel cell comprising a cathode; an anode; and an electrolyte membrane disposed between the cathode and the anode,
wherein at least one of the cathode, the anode and the electrolyte membrane comprises the double cross-linked polymer of claim 9.
